(19) United States
(12) Patent Application Publication
(10) Pub. No.: US 2025/0323689 A1
(43) Pub. Date: Oct. 16, 2025

(54) RECONFIGURABLE INTELLIGENT SURFACE CHANNEL STATE INFORMATION

(71) Applicant: InterDigital Patent Holdings, Inc., Wilmington, DE (US)

(72) Inventors: Deepa Gurmukhdas Jagyasi, London (GB); Patrick Svedman, Stockholm (SE); Allan Yingming Tsai, Boonton, NJ (US); Kyle Jung-Lin Pan, Saint James, NY (US); Arman Shojaeifard, London (GB); Guodong Zhang, Woodbury, NY (US); Ibrahim Hemadeh, Hemel Hempstead (GB)

(73) Assignee: InterDigital Patent Holdings, Inc., Wilmington, DE (US)

(21) Appl. No.: 18/868,803

(22) PCT Filed: May 26, 2023
(86) PCT No.: PCT/US2023/023643

§ 371 Date: Nov. 25, 2024

Related U.S. Application Data
(60) Provisional application No. 63/346,173, filed on May 26, 2022.

(51) Int. Cl. H04B 7/04; H04B 7/06; H04W 24/10

(52) U.S. Cl. CPC H04B 7/04013; H04B 7/0626; H04W 24/10

(57) ABSTRACT

Described herein are systems, methods and instrumentalities associated with a wireless communication network comprising a reconfigurable intelligent surface (RIS). A wireless transmit/receive unit (WTRU) in such a communication network may receive measurement configuration information that may indicate at least a first measurement resource and a second measurement resource. The first measurement resource may be associated with a first transmission path associated with a first subset of elements of the RIS, while the second measurement resource may be associated with a second transmission path independent of the RIS. The WTRU may perform measurements based on the measurement configuration information, and may transmit a report regarding at least one of the measurements to the network.

### CROSS-REFERENCE TO RELATED APPLICATIONS

This application claims the benefit of Provisional U.S. Patent Application No. 63/346,173, filed May 26, 2022, the disclosure of which is incorporated herein by reference in its entirety.

### BACKGROUND

Channels state information (CSI) acquisition may be performed in wireless communication systems, for example, based on reporting by a wireless transmit/receive unit (WTRU). The reporting may be based on measurements of reference signals such as a channel state information reference signal (CSI-RS). Reconfigurable intelligent surfaces have emerged as a promising technology for wireless communications, but problems associated with reconfigurable intelligent surfaces need to be addressed.

### SUMMARY

Described herein are systems, methods and instrumentalities associated with a wireless communication network comprising a reconfigurable intelligent surface (RIS). A wireless transmit/receive unit (WTRU) as described herein may include a processor, receiver, transmitter, and/or memory etc., as described herein. The WTRU may be configured to perform and may perform the actions described herein. The WTRU may receive measurement configuration information (e.g., from a network device, such as a base station), wherein the measurement configuration information may indicate at least a first measurement resource and a second measurement resource (e.g., in the same measurement resource set or different measurement resource sets). The first measurement resource may be associated with a first transmission path associated with a first subset of elements (e.g., a first row, column, or combination of elements) of a reconfigurable intelligence surface (RIS) (e.g., a transmission along the first transmission path may be reflected by the first subset of elements of the RIS), and the second measurement resource may be associated with a second transmission path independent of the RIS (e.g., a transmission along the second transmission path may be directly from the network device to the WTRU, for example, without reflection by the RIS). The WTRU may perform a first measurement using the first measurement resource indicated by the measurement configuration information, and perform a second measurement using the second measurement resource indicated by the measurement configuration information. The first measurement may be performed based on a first reference signal received via the first transmission path, while the second measurement may be performed based on a second reference signal received via the second transmission path. The WTRU may transmit a report regarding at least one of the first measurement or the second measurement to the network device (e.g., the report may indicate results of the first measurement and/or the second measurement).

At least one of the first reference signal or the second reference signal described herein may include a channel state information (CSI) reference signal, and the report transmitted to the network device may include a CSI report (e.g., the measurement configuration information may indicate respective channel quality parameters to be measured and reported). The first reference signal and the second reference signal may be received from a same multiple-input-multiple-output (MIMO) transmitter associated with the network device.

In examples, the measurement configuration information described herein may indicate a third measurement resource associated with a third transmission path aided by a second subset of elements (e.g., a second row, column, or combination of elements) of the RIS, and the WTRU may perform a third measurement based on a third reference signal received via the third transmission path. In examples, all or a subset of the first reference signal, the second reference signal, and the third reference signal may be time-division multiplexed (TDM'ed), and/or received during a reference signal transmission burst that may include multiple time slots.

In examples, The WTRU transmitting the report regarding at least one of the first measurement or the second measurement to the network device may comprise the WTRU transmitting a first report indicating a result of the first measurement using a first uplink grant, and transmitting a second report indicating a result of the second measurement using a second uplink grant. In examples, the WTRU may indicate the results of the first measurement and the second measurement in a same report.

In examples, the measurement configuration information may indicate that the first measurement resource and the second measurement resource are associated with respective resources indices, transmission times, transmission periodicities, and/or transmission power offsets, and the WTRU may determine that the first measurement resource is associated with the first transmission path and that the second measurement resource is associated with the second transmission path based on the respective resources indices, transmission times, transmission periodicities, or transmission power offsets associated with the first measurement resource and the second measurement resource.

A base station as described herein may include a processor, receiver, transmitter, memory, etc., as described herein. The base station may be configured to perform and may perform the actions described herein. The base station may receive information regarding an RIS and may send measurement configuration to a WTRU, wherein the measurement configuration information may indicate at least a first measurement resource and a second measurement resource. The first measurement resource may be associated with a first transmission path to the WTRU that may use the RIS, while the second measurement resource may be associated with a second transmission path to the WTRU that may be independent of the RIS (e.g., not using reflection from the RIS). The base station may receive a report from the WTRU (e.g., in response to sending the measurement configuration information to the WTRU), wherein the report may indicate a result of at least one of a first measurement performed based on the first measurement resource or a second measurement performed based on the second measurement resource. The base station may determine whether to update a state of the RIS based on the report received from the WTRU. Based on a determination to update the state of the RIS, the base station may send a configuration message to the RIS, wherein the configuration message may indicate at least that the state of the RIS is to be updated.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an RIS-aided communication system.

FIG. 3 is a diagram illustrating an example RIS CSI procedure.

FIG. 4 is a diagram illustrating examples of signaling in a system comprising an RIS.

FIG. 5 is a diagram illustrating example operations that may be associated with a WTRU.

FIG. 6 is a diagram illustrating example operations that may be associated with an RIS.

FIG. 7(a), FIG. 7(b) and FIG. 7(c) are diagrams illustrating examples of organizing RIS elements into sub-surfaces.

FIG. 8 is a diagram illustrating an example of an RIS sub-surface.

FIG. 9 is a diagram illustrating an example procedure for a scenario-specific RIS sub-surface configuration update.

FIG. 10 is a diagram illustrating examples of element-wise RIS signaling.

FIG. 11 is a diagram illustrating examples of per sub-surface RIS signaling.

FIG. 12 is a diagram illustrating examples of CSI-RS resources.

FIG. 13 is a diagram illustrating examples of multi-port CSI-RS resources.

FIGS. 14(a)-14(i) are diagrams illustrating examples of multi-port CSI-RS resources with TDM'ed antenna ports.

FIG. 15 is a diagram illustrating examples of multiple multi-port CSI-RS resources.

FIG. 16 is a diagram illustrating examples of multiple CSI-RS resource sets in a CSI resource setting.

FIG. 17 is a diagram illustrating examples of multiple CSI-RS resource sets in a CSI resource setting.

FIG. 18 is a diagram illustrating examples of 8-port CSI-RS resources.

FIG. 19 is a diagram illustrating examples of 8-port CSI-RS resources.

FIGS. 20(a) and 20(b) are diagrams illustrating examples of CSI-RS resources associated with two users (e.g., two WTRUs).

FIG. 21(a) and FIG. 21(b) are diagrams illustrating examples of mapping orders.

### DETAILED DESCRIPITION

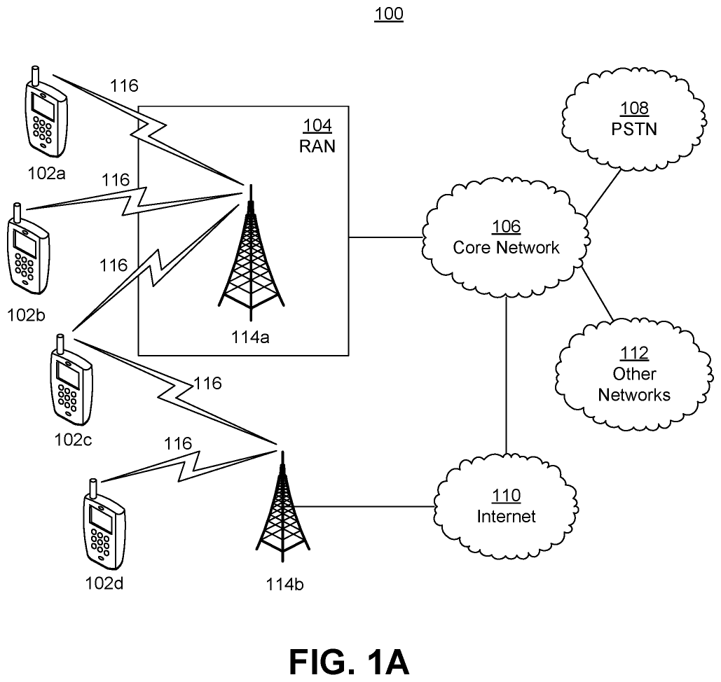

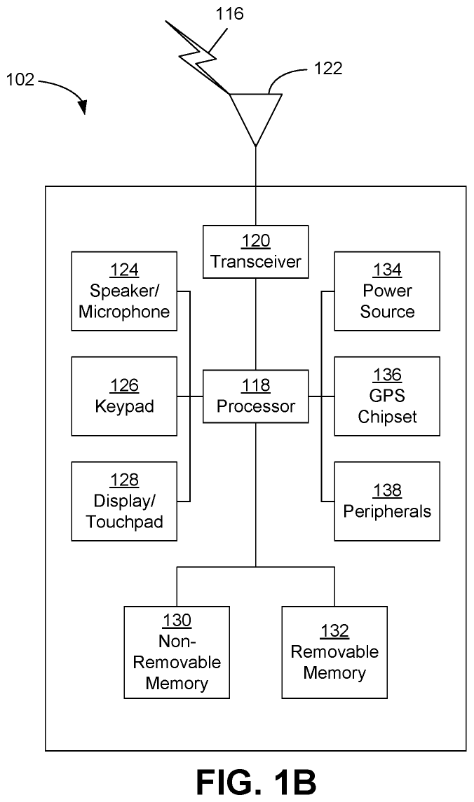

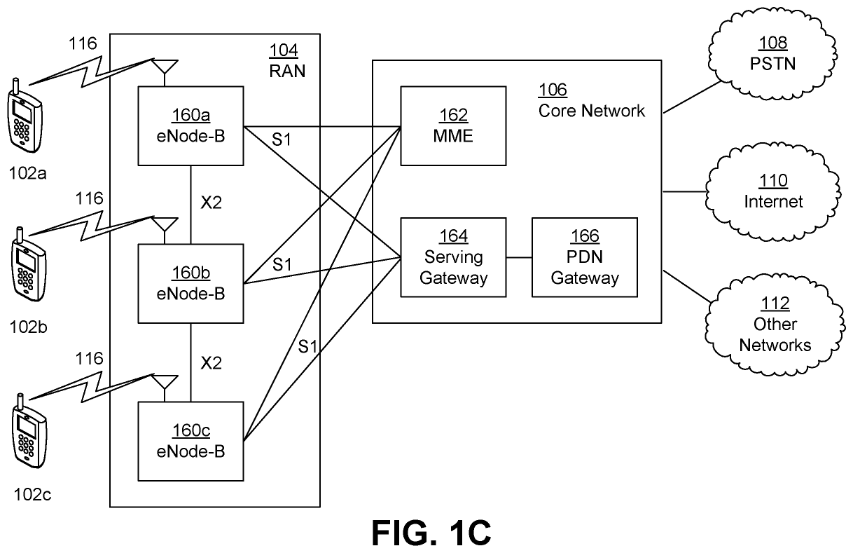

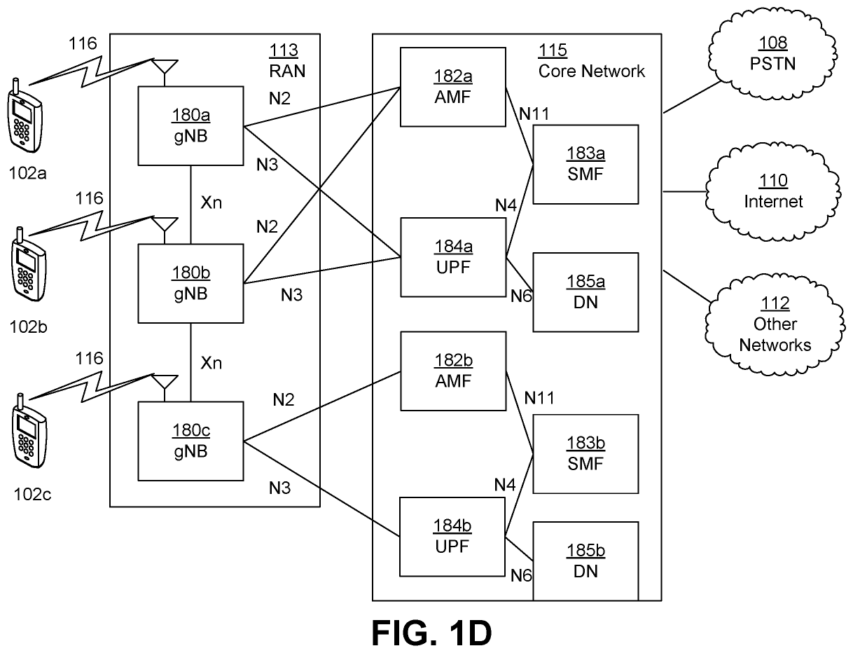

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

CSI may be used to adapt a transmission scheme, such as transmitter precoding. CSI acquisition may be based on reference signal measurement and reporting by a WTRU such as measurements of a CSI-RS. With the presence of a reconfigurable intelligent surface (RIS) in a wireless communication environment (e.g., a radio-based environment), CSI related procedures may be extended to incorporate an RIS state in the presence of additional links between the WTRU and the RIS (referred to herein as WTRU-RIS links or paths) and/or between a base station and the RIS (referred to herein as BS-RIS links or paths).

Methods may be provided for RIS CSI acquisition (e.g., RIS CSI determination and/or reporting). Sub-surface (e.g., which may correspond to a subset of RIS elements) based operations may be performed to reduce the complexity of channel estimation and/or CSI computation associated with an RIS, and/or to reduce CSI overhead (e.g., for an RIS with multiple elements). Suitable CSI-RS transmission schemes may be implemented. RIS-related measurement results and/or parameters may be included in a CSI report.

An RIS may be included in a wireless communication network, for example, due to its capability of enhancing wireless signal propagation. The RIS may include a planar surface comprising a large number of elements such as sub-wavelength sized scattering elements (referred to as RIS elements herein). An RIS element may alter (e.g., dynamically alter) the electromagnetic properties (e.g., phase and/or amplitude) of an impinging signal with an electronic RIS controller. For example, by properly optimizing the state of RIS elements, an impinging signal may be directed towards a desired receiver to improve communication performance (e.g., for higher spectral efficiency, enhanced coverage, etc.). Along with providing an improved wireless communication environment, RIS elements may support applications such as joint communication, sensing, and/or wireless power transfer. RIS elements may also support features such as reflection, refraction, focusing, collimation, polarization, etc. An RIS may be classified as passive, semi-active, or active. A passive RIS may shift (e.g., only shift) the phase of an impinging signal and may include multiple passive elements. A semi-active and/or active RIS may offer phase shift and/or amplification gains. A semi-active RIS may include a mixture of active and passive elements, while an active RIS may include all active elements (e.g., only active elements). Active RIS elements may possess sensing capabilities. As an RIS may be considered a communication or network node, RIS-aided communications may involve at least three nodes, e.g., a base station (BS), a WTRU, and an RIS. A communication path may be established to include a BS-RIS-WTRU path along with a BS-WTRU communication path. Various communication procedures including initial access, beamforming, control signaling, channel acquisition, CSI measurement and reporting, etc., may be updated to enable an RIS-aided communication path and/or to support the introduction of an RIS into a network. For example, channel acquisition and/or CSI reporting may be adapted in an RIS-aided communication scenario.

Henceforth, the term RIS may denote an RIS, the combination of an RIS and an RIS controller, or an RIS controller. A base station may communicate with an RIS (e.g., via an air interface) and provide the RIS with control information. An RIS system may include one or multiple RIS elements, which may be organized into sub-surfaces (e.g., each sub-surface may include a subset of elements of the RIS). In some examples provided herein, an RIS may be described in the context of a downlink (DL), but the same or similar techniques may also be applicable to an uplink (UL).

For ease of description, a single-antenna WTRU and a narrowband system (e.g., a subcarrier of an OFDM-based system) may be used in the examples provided herein. But the techniques described in those examples may also be applicable to a multi-antenna WTRU such as a WTRU that may combine multiple received signals into a single signal based on receiver processing (e.g., using analog, digital, or hybrid beamforming or combining techniques). In examples, such receiver processing may be applied to a radio channel.

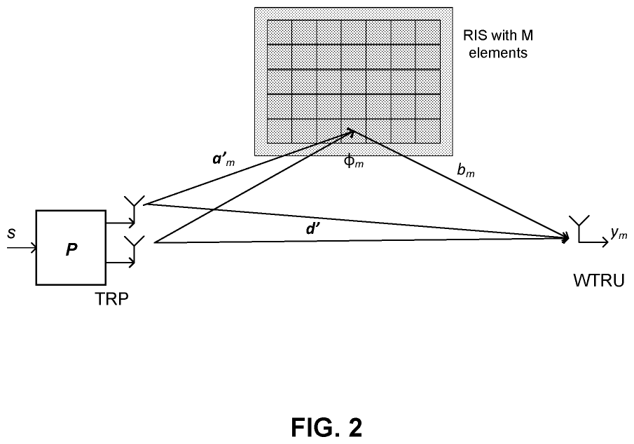

In a first example model, an RIS system may utilize only one element of an RIS (e.g., out of M RIS elements), as illustrated in FIG. 2. In this model, an equivalent baseband received complex-valued scalar signal yₘ at a WTRU (e.g., a signal received via an RIS-reflected path and/or a direct path, in the form of a complex-valued scalar) may be given by Equation 1 below.

$${y}_{m} = ( {b}_{m} {a}_{m}^{′} {ϕ}_{m} + {d}^{′} ) Ps + z = ( {c}_{m}^{′} {ϕ}_{m} + {d}^{′} ) Ps + z \qquad ( 1 )$$

wherein s may represent a complex-valued scalar symbol such as a known reference (e.g., pilot) symbol, P may represent a complex-valued precoding vector of dimension N_{T}×1 (e.g., N_{T} may be the number of transmit antennas or antenna ports at a transmission reception point (TRP)), and

$${d}^{′} = [ {d}_{0}^{′} ⋯ {d}_{{N}_{{T}^{- 1}}}^{′} ]$$

may represent a complex-valued channel between the TRP and the WTRU (e.g., excluding propagation paths via an RIS of dimension 1×N_{T}). In addition,

$${a}_{m}^{′}$$

may represent a complex-valued vector channel (e.g., of dimension 1×N_{T}) between the TRP and the RIS element,

$${c}_{m}^{′} = {b}_{m} {a}_{m}^{′}$$

may represent a cascaded complex-valued vector channel (e.g., of dimension 1×N_{T}) between the TRP, RIS element m, and the WTRU, and ϕₘ may represent a complex-valued scalar RIS element factor of RIS element m, where m=1, . . . , M. Further, bₘ may represent a complex-valued scalar channel between the RIS element and the WTRU, and z may represent additive noise and/or interference.

With a passive RIS, factor ϕₘ may have a fixed amplitude, such as, e.g., a unit amplitude (|ϕₘ|=1). With an active or hybrid RIS, the amplitude of ϕₘ may be variable and/or controllable. In some examples (e.g., for a passive RIS), the RIS element may be turned off (e.g., ϕₘ=0 or ϕₘ≈0). At a given time, the RIS element may be in a certain state (ϕₘ), which may be assumed to be applicable to one or more (e.g., all) sub-carriers of a certain bandwidth.

The terms reference signal (RS) and pilot may be used interchangeably herein. With OFDM, an RS or pilot may comprise multiple (e.g., known) symbols, which may be mapped to different sub-carriers and/or OFDM symbols.

The example shown in FIG. 2 may be simplified, for example, by including TRP precoding P into a TRP-to-RIS channel. Equation 2 below may be applicable in such a scenario:

$${y}_{m} = ( {b}_{m} {a}_{m} {ϕ}_{m} + d ) s + z = ( {c}_{m} {ϕ}_{m} + d ) s + z \qquad ( 2 )$$

wherein d=d′P may represent a complex valued scalar effective direct TRP-to-RIS channel (e.g., including TRP precoding),

$${a}_{m} = {a}_{m}^{′} P$$

may represent a complex-valued scalar channel between the TRP and the RIS element, and cₘ=bₘaₘ my represent a cascaded complex-valued scalar channel from the TRP to an m:th RIS element and further to the WTRU.

In a second example model, an RIS system may utilize multiple RIS elements of an RIS (e.g., all M RIS elements of the RIS). Such a system may be established, for example, by including signals corresponding to the RIS elements (e.g., MRIS elements) of the RIS (cₘϕₘs) in the system, as shown by Equation 3 below:

$$y = ( ( a ⊙ b ) Φ + d ) s + z = ( c Φ + d ) s + z \qquad ( 3 )$$

wherein a may represent a complex-valued vector channel between the TRP and the RIS having a dimension of 1×M (e.g., M may be the number of RIS elements), b may represent a complex-valued vector channel between an RIS element and the WTRU (e.g., having a dimension of 1×M), and c=a⊙b=b⊙a may represent an element-wise (e.g., Hadamard) vector product of a and b. In addition, Φ may represent a complex-valued vector of dimension M×1 containing the M RIS element factors om and may correspond to an RIS state. In examples (e.g., with a rectangular RIS), Mₓ may denote the number of RIS elements in a first direction (e.g., horizontal), M_{y} may denote the number of RIS elements in a second direction (e.g., vertical), and M may be equal to Mₓ*M_{y}.

If an RIS is present in a communication network, there may exist multiple paths for a receiver node (e.g., a WTRU), such as, e.g., an RIS-aided path (e.g., a BS-RIS-WTRU path) and a direct path (e.g., a BS-WTRU path, which may also be referenced to herein as an RIS-independent path). The RIS-aided path may include a (e.g., any) path involving the RIS (e.g., using reflections of the RIS). The direct or RIS-independent path may exclude the RIS (e.g., a signal transmitted on the direct path may not be reflected by a sub-face or subset of elements of the RIS). The direct path may be used for signals (e.g., super-imposed signals) from multiple (e.g., all) reflected paths or a combined signal (e.g., in the case of multi-TRP transmission schemes). Channel properties may be controlled by introducing phase and/or amplification gains to an impinging signal on an RIS surface. Channel estimation (e.g., CSI measurements) may be performed in an RIS-aided system (e.g., on the direct path and/or the RIS-aided path) to improve communication performance.

When described herein, channel estimation may include cascaded channel estimation and/or separated channel estimation. In cascaded channel estimation, an overall effective channel (e.g., represented by bₘaₘ′ϕₘ shown in FIG. 2) may be estimated at a WTRU and/or a base station (e.g., a gNB) in the case of downlink or uplink channel estimation, respectively. In separated channel estimation, a channel associated with a BS-RIS path (e.g., aₘ′) and/or a channel associated with an RIS-WTRU path (e.g., bₘ) may be estimated individually. The specific channel estimation technique applied by a WTRU or a base station may be dependent on an RIS state.

An example approach for cascaded channel estimation may include an “on-off” method. In the on-off method, channel estimation may be performed as a multiple-step (e.g., two-step) process where, in a first step, one or more (e.g., all) RIS elements may be turned off and a direct channel may be estimated, and, in a second step, the RIS elements of the RIS may be turned on (e.g., one-by-one) and the channel gains introduced by each RIS element may be calculated. The overall channel may be estimated by combining the channel gains from the direct path and the channel gains from the RIS elements.

Another example approach for cascaded channel estimation may include an “on” method, which may avoid turning off RIS elements during pilot signal transmissions. Different Φ (factor) vectors, such as, e.g., orthogonal vectors, that may be known to a WTRU may be applied during the pilot signal transmissions. Direct and/or RIS-aided channels may be estimated by inverting the effect of the Φ vectors.

A large number of RIS elements may make a channel estimation task computationally intensive. Channel estimation in an RIS-aided communication system may be performed on multiple communication paths including, e.g., an RIS-aid communication path and a direct (e.g., RIS-independent) communication path. Hardware limitations and/or infinite resolution phase shifts may make channel estimation difficult in practical implementations. The resolution of phase shifters may define the number of possible states achievable by an RIS. Discrete phase shifters (e.g., which may be practically utilized) may introduce quantization errors that may affect the channel estimation at a receiver.

Channel estimation may be performed with a per-RIS element granularity. For example, to estimate the cascaded channel c in Equation 3 and/or the direct channel d, a network device may transmit a number of known pilot (reference) signals in symbols s. Since c may include M elements and d may include one element, M+1 pilots may be used to estimate the channel coefficients.

For simplicity of notation, the same pilot symbols s (which may also be referred to herein as pilot signals) may be assumed herein in M+1 occasions, but those skilled in the art will appreciate that the pilot symbols may also be different in different occasions (e.g., according to a certain complex-value sequence, as long as it is known by a WTRU). The received pilot symbols may be combined, e.g., in accordance with Equation 4 below:

$$y = h Θ s + z \qquad ( 4 )$$

wherein y=[y₀ . . . y_{M}] may represent the M+1 received pilot symbols and h=[d c] may represent a 1×(M+1) vector with a direct channel and M channels via the RIS. Θ may be equal to

$$[ \begin{matrix}1 & ⋯ & 1 \\ {Φ}_{0} & ⋯ & {Φ}_{M}\end{matrix} ] ,$$

where Φᵢ may be an M×1 vector with RIS element factors during the i:th pilot symbol, and Θ may be a square matrix with a dimension of (M+1)×(M+1). z=[z₀ . . . z_{M}] may represent a 1×(M+1) dimensional vector associated with received noise and/or interference.

In examples (e.g., with Θ having a full rank known to the WTRU), channels may be estimated based on y, e.g., in accordance with Equation 5 below. The channels may also be estimated based on minimum mean square errors (MMSE).

$$\hat{h} = \frac{1}{s} y {Θ}^{- 1} \qquad ( 5 )$$

Φᵢ may be designed using different approaches. For example, in the on-off method described herein, RIS elements (e.g., all RIS elements) may be turned off during a pilot symbol such as a first pilot symbol, which may result in Φ₀=0 or Φ₀≈0. This may lead to a received symbol y₀=ds+z₀.

The direct channel d may be estimated by the WTRU. For example, during pilot symbols 1 to M, RIS elements may be turned on one-by-one (e.g., while the other elements are still turned off). This may result in a i:th pilot symbol being received, for example, as shown by Equation 6.

$${y}_{i} = ( c {Φ}_{i} + d ) s + z = ( {c}_{i} {ϕ}_{i} + d ) s + {z}_{i} with i = 1 , … , M \qquad ( 6 )$$

For i>0, Φᵢ may have a zero value (e.g., all zero values), except that the i:th element of the vector may be equal to 1 (e.g., ϕᵢ=1). For example, Φ₁ may be equal to [1 0 . . . 0]^{T}, Φ₂ may be equal to [0 1 0 . . . 0]^{T}, etc. As another example, [Φ₁ . . . Φ_{M}] may be equal to I_{M}, wherein I_{M} may be a M-dimensioned identity matrix. In these examples, it may be assumed that the RIS elements may be turned on in an order based on RIS element indices, but those skilled in the art will understand that the elements may be turned on in any order.

In examples (e.g., such as the on method described herein), Φᵢ may be vectors without a zero-valued element. This may mean that multiple (e.g., all) RIS elements may be turned on during pilot symbol transmissions. Θ may be a DFT matrix, a Hadamard matrix, and/or the like, and RIS states during the pilot transmissions may be based on the columns of the DFT matrix or Hadamard matrix. In at least these examples, Θ⁻¹ may be equal to Θ^{T}, which may simplify implementation.

DL CSI acquisition (e.g., a first mode of DL CSI acquisition) may be based on a WTRU performing measurements on one or more CSI-RSs and reporting the corresponding CSI measurement results. DL CSI acquisition (e.g., a second mode of DL CSI acquisition) may be based on a WTRU transmitting a sounding reference signal (SRS) (e.g., including antenna switching between antennas that may be used for DL reception), a network device performing CSI measurements, and/or the assumption of UL/DL reciprocity (e.g., CSI estimated on the UL may be applicable to the DL).

A WTRU may be configured to perform channel measurement and/or determine (e.g., compute) CSI using at least one CSI-RS resource, which may be associated with one or multiple antenna ports. The WTRU may be configured to perform interference and/or noise measurements (e.g., by measuring a signal to interference and noise ratio (SINR)) using at least one CSI-RS resource. One or multiple CSI-RS resources may be grouped into a CSI-RS resource set. The CSI-RS resources may be non-zero power (NZP) CSI-RS resources, in which the WTRU may assume a certain RS is transmitted. The CSI-RS resources may be CSI-RS resources for interference measurement, in which the WTRU may assume no RS is transmitted. As such, the CSI-RS resources and resource sets described herein may be, for example, non-zero power (NZP) CSI-RS resources and resource sets, or interference measurement (IM) CSI-RS resources or resource sets. For brevity, the terms CSI-RS resource(s) and CSI-RS resource set(s) may be used herein to refer to NZP and/or IM CSI-RS resource(s) and resource set(s).

A CSI-RS resource may be periodic, semi-persistent (e.g., capable of being activated/deactivated), or aperiodic (e.g., triggered by a certain condition). A WTRU may be configured with periodic, semi-persistent, or aperiodic CSI reporting. In examples, periodic CSI reports may be transmitted on the PUCCH, aperiodic CSI reports may be transmitted on the PUSCH, and semi-persistent CSI reports may be transmitted on the PUCCH or on a semi-persistent PUSCH.

A CSI report may be based on channel measurements performed using a resource set such as a CSI-RS resource set. A (e.g., each) channel measurement resource may be associated with an interference measurement resource and/or a non-zero power CSI-RS resource for channel measurement. A WTRU may report CSI corresponding to one or more resources in a resource set for channel measurement. If the resource set includes multiple resources, the WTRU may report a resource index, for example, to identify the corresponding resource used for the measurement. Such a resource index may, for example, include a CSI-RS resource indicator (CRI) or an SSB resource indicator (SSBRI).

In examples (e.g., if a multi-port CSI-RS is used as a channel measurement resource), a WTRU may be configured to compute one or more precoding matrix indicators (PMI), which may include a wideband PMI and/or a number of sub-band PMIs. The PMI may, for example, correspond to a precoding vector or a precoding matrix selected directly from a codebook. The PMI may include a combination (e.g., a linear combination) of multiple precoding vectors or precoding matrices from a codebook. In examples, a CSI report may include a channel quality indicator (CQI), which may be a wideband CQI (e.g., if wideband PDSCH transmission is performed) and/or a sub-band CQI (e.g., if sub-band PDSCH transmission is performed). If the CSI report includes a PMI, the CQI may correspond to a set of layers associated with the PMI.

A WTRU may receive (e.g., be scheduled with) one or multiple CSI-RS resources and may acquire downlink CSI using the CSI-RS resources. The WTRU may perform measurements on an acquired channel and may transmit acquired CSI to a base station (e.g., in a corresponding CSI report) based on the performed measurements (e.g., via the PUCCH or PUSCH). In RIS-aided communications, there may be multiple (e.g., two) communication paths between a base station and the WTRU, including, for example, a first path involving an RIS (e.g., using the RIS to reflect a signal) and a second path independent of an RIS (e.g., the second path may be a direct path between the base station and the WTRU, not aided by the RIS). When an RIS is present in a communication system, the RIS may introduce phase shifts and/or amplification to an impinging signal, for example, based on a predefined or preset RIS state that may be configured by an RIS controller. The RIS may reflect an incident beam in a desired direction. The RIS state may be an effective part of a received reference signal at the WTRU that may be predefined or preset due to the existence of the RIS-aided communication path.

Legacy CSI acquisition procedures may not support an RIS-aided communication path and/or may not be able to distinguish between a direct path and an RIS-aided path. The techniques disclosed herein may allow a WTRU to acquire knowledge about an RIS state (e.g., which may be communicated explicitly or implicitly to the WTRU from a base station or an RIS controller) and estimate channels (e.g., CSI) associated with an RIS-aided path. With these techniques, configuration parameters and/or mechanisms may be adapted (e.g., optimized) based on the presence of an RIS to improve the performance of a wireless communication system.

Legacy CSI reports, such as those including legacy RI, PMI, and/or CQI parameters, may be insufficient to capture the effect of an RIS state. CSI measurement (e.g., estimation) and/or CSI reporting by a WTRU to a base station may be used by the base station for link adaptation (e.g., such as adjusting a BS transmission scheme in terms of modulation and coding), for multi-antenna precoding, and/or for frequency domain resource allocation. Adjustments made by the base station and/or the WTRU to an RIS state may pertain to improving a received signal quality such as that associated with precoding and/or frequency-selective scheduling, and/or to achieving a certain block error rate such as that associated with modulation and coding scheme (MCS) selection. The adjustment of an RIS state may be similar to precoder selection, for example, in terms of improving a received signal quality. Legacy CSI procedures may not support efficient CSI-based RIS state adjustment.

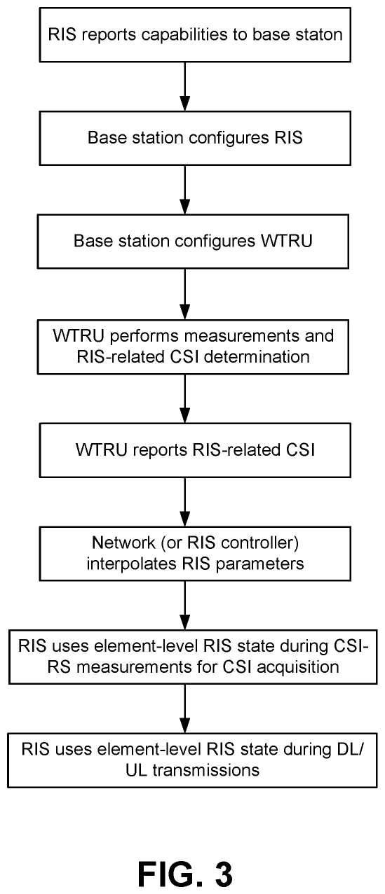

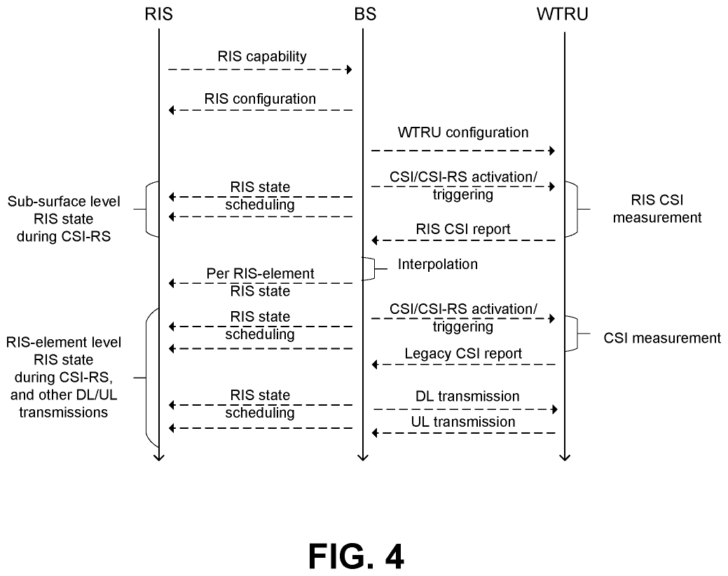

As describe herein, a wireless communication system may include various nodes, such as one or more base stations (e.g., gNBs), one or more TRPs, one or more RISs, one or more WTRUs, etc. CSI procedures for such a system may be configured to accommodate the RISs. FIG. 3 illustrates an example of such a CSI procedure. FIG. 4 illustrates example signaling that may occur in a communication system comprising an RIS. It should be noted that additional operations that are not shown in FIG. 3 may also be performed in various examples and some operations shown in FIG. 3 may be omitted in various examples. In addition, while the RIS state in FIG. 3 may be described as being defined at an RIS element level, the RIS state may also be defined at a sub-surface level (e.g., a sub-surface may include multiple elements). Further, additional signaling that is not shown in FIG. 4 may also be performed in various examples and some signaling shown in FIG. 4 may be omitted in various examples.

As shown in FIG. 3 and/or FIG. 4, an RIS may signal (e.g., report or otherwise indicate) its capabilities to a base station (BS). This may be followed by the base station configuring the RIS and/or a WTRU. The WTRU may perform RIS CSI measurements, for example, based on a CSI-RS transmitted by the base station. In the case of semi-persistent or aperiodic CSI-RS, the WTRU may receive corresponding activation or triggering signaling that may be transmitted by the base station. The base station may indicate to the RIS that a particular RIS state may be used at certain times (e.g., to use a sub-surface level RIS state in symbols that may carry a CSI-RS for RIS CSI). This operation may be shown as RIS state scheduling in FIG. 4. The WTRU may (e.g., following RIS CSI measurements and/or computation) report the RIS CSI to the base station. Based on the RIS CSI report, the base station may perform RIS parameter interpolation, for example, to obtain an RIS-element level RIS state, and may indicate the RIS-element level RIS state to the RIS, e.g., for later use. Subsequently, additional CSI measurements and reporting (e.g., legacy CSI measurements and reporting) may be performed based on the RIS-element level RIS state that may available at the RIS. In the case of semi-persistent or aperiodic CSI-RS or CSI reporting, the WTRU may receive corresponding activation or triggering signaling. The base station may schedule the use of RIS-element level RIS states during certain times (e.g., in symbols that may carry CSI-RS resources and/or symbols that may carry CSI reports). DL and/or UL transmissions may be performed, for example, on the PDSCH and/or PUSCH, respectively, following the CSI measurements and/or reporting. The base station may schedule the RIS to use a suitable RIS state in symbols that may carry the DL and/or UL transmissions. This way, enhanced performance may be obtained based on the RIS state (e.g., RIS-element level RIS state).

Different types or classes of RISs may be supported in the wireless communication system described herein. For example, RISs in the communication system may differ with respect to the number of RIS elements (e.g., M), the number of horizontal/vertical RIS elements (e.g., Mₓ and/or M_{y}), the range and/or resolution of RIS element amplifications and/or phase shifts, sub-surface and/or parameter interpolation capability, etc. A range as described herein may include a minimum value and a maximum value, for example, for RIS element amplification. A resolution as described herein may include a step size between supported values within a range. For example, a phase shift resolution of π/16 may be supported for an RIS. A resolution or range capability may list the supported values.

An RIS capability as described herein may include a set of parameters related to the aspects that may differ between different RISs. An RIS class may be defined based on one or more capabilities. An RIS may connect to a network device and report its capabilities and/or class (e.g., class 1, class 2, etc.) to the network device (e.g., as shown in FIG. 3 and FIG. 4). The RIS may report its capabilities and/or class using an RRC message, for example.

An RIS may be configured by a network device such as a base station (e.g., a gNB), as illustrated in FIG. 3 and FIG. 4. The configuration may be performed via one or more RRC configuration messages (e.g., via RRC signaling). When referred to herein, the term “RIS state” may correspond to certain settings of RIS element factors (e.g., such as amplification, phase shift, etc.), whereas the terms “RIS configuration” and “sub-surface configuration” may correspond to RRC configuration information associated with an RIS that may be conveyed via RRC signaling. Further, the term “legacy” may refer to operations (e.g., including CSI measurement and reporting operations) that may not involve an RIS or independent of an RIS.

The configuration information (e.g., parameters) for an RIS may include one or more of the following. The configured information may include sub-surface related parameters such as a sub-surface configuration ID and/or multiple sub-surface configurations associated with a number of sub-surfaces (e.g., a sub-surface configuration ID may be used to identify a respective sub-surface configuration). The configured parameters may include a number of sub-surfaces (e.g., S), a number of horizontal sub-surfaces (e.g., Sₓ), a number of vertical sub-surfaces (e.g., S_{y}), a number of RIS elements per sub-surface, a number of RIS elements per horizontal sub-surface, a number of RIS elements per vertical sub-surface, an RIS element factor resolution (e.g., phase resolution), etc.

The configuration information for an RIS may include time-domain configuration information for a sub-surface configuration and/or an RIS state, which may indicate the time instances when the sub-surface configuration and/or RIS state may be used. The time-domain configuration information may include, for example, configuration ID(s) (e.g., sub-surface configuration ID, RIS state ID, etc.) to which the time-domain configuration information may apply (e.g., the time domain configuration information may be included in a sub-surface and/or RIS state configuration). The time-domain configuration information may indicate time-domain behaviors (e.g., periodic or semi-persistent) of the configuration, periodicity, time offset, and/or duration (e.g., in terms of slots, symbols, or milliseconds) of the configuration, a numerology (e.g., an integer index u that may correspond to a slot duration of 2^{-μ} milliseconds), etc. A time reference associated with the time-domain configuration information may be given based on the timing of the cell in which the configuration may be provided to the RIS. The time-domain configuration information may be applicable to periodic or semi-persistent time-domain behaviors.

The configuration information for an RIS may include trigger state configuration information, which may be applicable to aperiodic time-domain behaviors of a sub-surface or an RIS state. The trigger state configuration information may indicate a set of trigger states, wherein a trigger state may correspond to a parameter value included in a DCI. The trigger state configuration information may associate a trigger state with a sub-surface configuration (e.g., via a sub-surface configuration ID) and/or an RIS state (e.g., via an RIS state ID).

The configuration information for an RIS may include information that indicates the respective ranges and/or resolutions of the RIS elements and/or sub-surface factors (e.g., amplification, phase-shifts, etc.) of the RIS. Such information may be provided, for example, in the form of one or more codebooks, or a numbers of bits (e.g., the bits used to cover the respective ranges of the phase shifts).

The configuration information for an RIS may include one or more RIS states and/or RIS state IDs that may be associated with one or more sub-surface configurations. In examples, sub-surface configurations may not be provided, in which case RIS-element based operations may be performed. In examples, sub-surface configurations may be provided at an RIS element level (e.g., each RIS element may be treated as a sub-surface).

A network device such as a base station (BS) may configure a WTRU with parameters related to RIS CSI enhancements, as shown in FIG. 3 and FIG. 4. The RIS CSI related configuration parameters or configuration information may include one or more of the following. The configuration information may include sub-surface level configuration information, such as the parameters of the sub-surface RIS configuration discussed herein. The configuration information may include information about a sub-surface configuration that may be useful for the WTRU to perform RIS CSI computation. For instance, the WTRU may be informed about which sub-surfaces (or corresponding pilot signals) may be adjacent in a certain direction (e.g., along the x axis of a 2D space) such that the WTRU may estimate a phase gradient across multiple sub-surfaces in that direction.

The configuration information may include legacy CSI reporting configuration information, such as, e.g., channel quality related parameters to be measured (e.g., CQI related reporting configuration information). The configuration information may include enhanced CSI reporting configuration information, such as, e.g., one or more of the RIS parameters described herein (e.g., RIS related channel quality parameters to be measured such as RIS-QI, etc.). The configuration information may include legacy CSI resource configuration information. The configuration information may include enhanced CSI resource or resource set configuration information such as, e.g., an enhanced CSI-RS resource set configuration including S+1 CSI-RS resources (e.g., S may correspond to the number of sub-surfaces of an RIS). In examples, a WTRU may be configured with multiple CSI-RS resource sets, with one or more resource sets dedicated for RIS CSI measurement and reporting, and one or more other resource sets dedicated for legacy operations such as legacy CSI acquisition, beam management, etc.

Based on the configuration information described herein, a WTRU may receive one or more reference signals, perform measurements of the reference signals, and compute (e.g., determine) CSI that may include one or more parameters associated with an RIS, as illustrated in FIG. 3 and FIG. 4. For example, the WTRU may estimate per sub-surface phase shifts based on an enhanced CSI-RS resource set associated with an RIS. As such, a CSI report transmitted by the WTRU may include RIS related CSI parameters (e.g., only RIS related CSI parameters), or RIS and legacy CSI parameters (e.g., such as legacy CQI, PMI, RI, etc.). The WTRU may send the CSI report (e.g., based on the configuration information described herein) to a network device (e.g., a base station), for example, in one or more PUCCH transmissions or one or more PUSCH transmissions, as illustrated in FIG. 3 and FIG. 4. The WTRU may include the RIS CSI in UL control information (UCI) or in a MAC control element (CE). The CSI report may also include one or more RIS parameters.

Based on the reported RIS CSI (e.g., which may include one or more RIS parameters), a network device may interpolate a sub-surface-level RIS state to an element-level RIS state, as shown in FIG. 3 and FIG. 4. The interpolation may be performed by the base station that receives the CSI report, by another network node (e.g., another base station or a core network device), by an RIS (e.g., an RIS controller), and/or the like. If the interpolation is performed by another network node, the network (e.g., the base station responsible for configuring the RIS) may indicate to the RIS or configure the RIS with the interpolated RIS state (e.g., at a per RIS-element level), which may be associated with an RIS state ID. If the interpolation is performed by an RIS (e.g., an RIS controller), the network may indicate to the RIS or configure the RIS with the WTRU-reported RIS parameter(s). The RIS (e.g., an RIS controller) may perform the interpolation from the WTRU-reported RIS parameter(s) to the per RIS-element factors. The network may indicate an association between the resulting (e.g., post-interpolation) RIS state and an RIS state ID. The interpolation may be omitted, for example, if sub-surfaces are not used or not configured, or if the sub-surface granularity is an RIS element (e.g., if each RIS element corresponds to a sub-surface).

CSI may be measured and/or reported at an RIS-element level. For example, based on its configuration, a WTRU may receive one or more reference signals, perform measurements of the reference signals, and compute (e.g., determine) CSI (e.g., CQI, RI, PMI, etc.) based on the measurements. The WTRI may perform channel measurements using one or more CSI-RS resources included in a CSI-RS resource set. A network device such as a base station may indicate to or configure an RIS to use an element-level RIS state during the one or more CSI-RS resources. The network device may do so, for example, by configuring, indicating, triggering, and/or activating time-domain configuration information for the element-level RIS state that may overlap in time with the one or more CSI-RS resources. The network device may indicate to the RIS or configure the RIS to use the element-level RIS state during subsequent DL/UL transmissions. The network may do so, for example, by configuring, indicating, triggering, and/or activating time-domain configuration information for the RIS state that may overlap in time with one or more of the DL/UL transmissions. The DL transmissions may include PDCCH, PDSCH, CSI-RS, TRS, and/or PRS transmissions, while the UL transmissions may include PUCCH, PUSCH, and/or SRS transmissions. The use of a certain RIS state may be dynamically indicated or scheduled, as illustrated in FIG. 4.

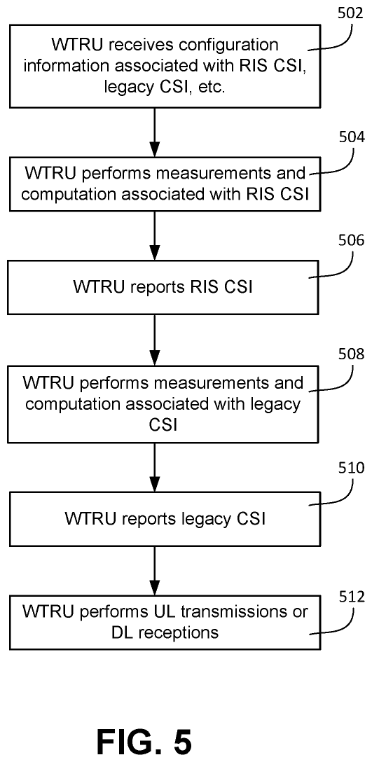

FIG. 5 illustrates an example procedure associated with CSI measurement and reporting (e.g., following one or more of the operations illustrated in FIG. 3). As shown, at 502, a WTRU may be configured with RIS CSI and/or legacy CSI related configuration information. At 504, the WTRU may perform RIS CSI measurements and/or computation, which may be based on one or more CSI-RSs transmitted by a base station. In the case of semi-persistent or aperiodic CSI-RS, corresponding activation or triggering signaling may be performed (e.g., also at 504). At 506, the WTRU may report the RIS CSI based on the RIS CSI measurements and/or computation. At 508, the WTRU may perform legacy CSI measurements computation (e.g., CSI independent of the RIS), and may report the measurements and/or computation (e.g., including CQI) to the base station at 510. In the case of semi-persistent or aperiodic CSI-RS or CSI reporting, corresponding activation or triggering signaling may be provided (e.g., at 510). At 512, the WTRU may performed DL reception and/or UL transmission (e.g., on the PDSCH and/or the PUSCH, respectively).

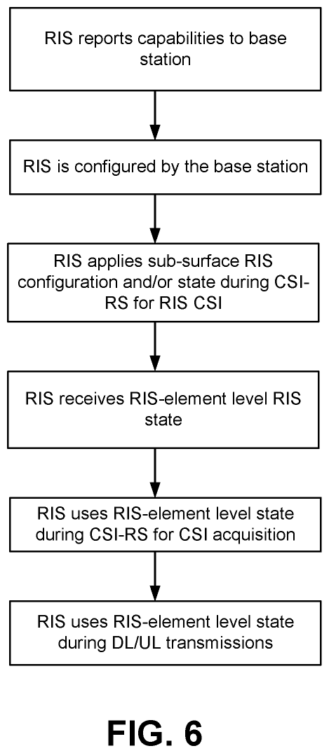

FIG. 6 illustrates an example RIS procedure (e.g., which may be performed following one or more of the RIS-side operations illustrated in FIG. 3) associated with CSI measurements and/or reporting.

In examples, the number of RIS elements on an RIS may be high and performing channel estimation and/or CSI reporting at an RIS element level may be costly (e.g., in terms of overhead and signaling). The cost may be reduced, for example, by introducing sub-surface-based estimation and reporting. The RIS elements may be distributed (e.g., organized or grouped) into S sub-surfaces including, for example, Sₓ horizontal elements and S_{y} vertical elements in a sub-surface. The distribution of the RIS elements into the sub-surfaces may be uniform (e.g., same number of RIS elements per sub-surface) or non-uniform (e.g., different numbers of RIS elements for different sub-surfaces). In the case of a multi-panel RIS, a (e.g., each) panel may be considered a sub-surface, or a (e.g., each) panel may be divided into multiple sub-surfaces.

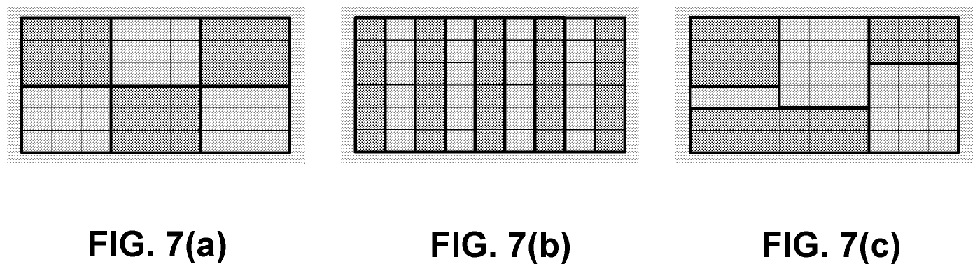

FIGS. 7A-7C illustrate examples of RIS element distribution into sub-surfaces. FIG. 7A and FIG. 7B illustrate examples of uniform distribution, while FIG. 7C illustrates an example of non-uniform distribution. In the case where different RIS surfaces may be allocated to different users, the number of RIS elements or resources allocated to a user (e.g., a WTRU) may be increased or decreased (e.g., non-uniform RIS distribution may be used). A WTRU requesting more resources may be allocated a sub-surface with a bigger size or dimension (e.g., having more RIS elements), whereas a WTRU with a less-stringent request may be allocated a sub-surface with a smaller size or dimension (e.g., having fewer RIS elements).

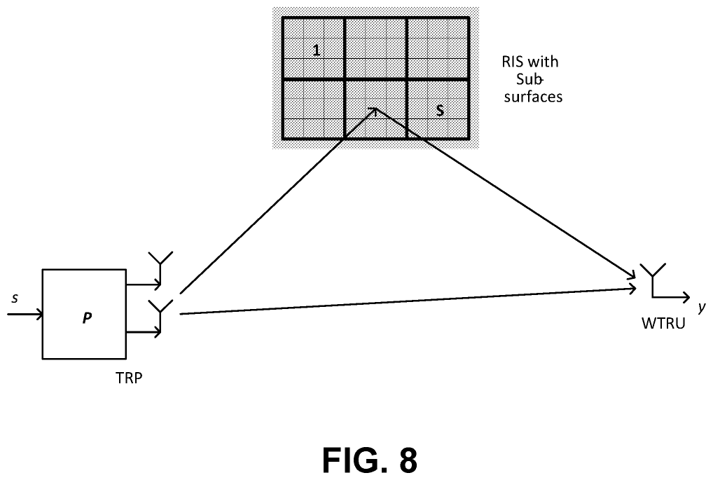

The number of pilots (e.g., reference signals) for CSI and/or channel acquisition may be M+1 for an RIS with M elements (e.g., in the case of element-wise RIS channel estimation). With increased RIS surface size, the computational complexity of the estimation process may increase tremendously, making the process of channel estimation inefficient and/or time-consuming. In examples, channel estimation may be performed by dividing and/or grouping RIS elements into smaller groups (e.g., which may be referred to herein as sub-surfaces) and performing the channel estimation at a sub-surface level. Such a sub-surface may include a set of one or more RIS elements. The distribution of RIS elements into sub-surfaces may be uniform or non-uniform. In the case of a multi-panel RIS, a (e.g., each) panel may be considered a sub-surface, or a (e.g., each) panel may be further divided into multiple sub-surfaces. FIG. 8. illustrates an example of partitioning an RIS into six sub-surfaces (e.g., S=6).

An RIS state may be configured at a sub-surface level (e.g., the same RIS element factor may be applied to the RIS elements in a sub-surface). Sub-surface level channel estimation may be performed by configuring and sending a (e.g., one) pilot (e.g., reference signal) per sub-surface (e.g., rather than a pilot per RIS element). By introducing the sub-surfaces, the dimension of the channel estimation problem may be reduced from M+1 to S+1 (e.g., in terms of the number of reference signa resources configured, the number of reference signals transmitted, and/or the number of CSI computations performed). The on-off method and/or the on method described herein may be applied to sub-surfaces (e.g., instead of to individual RIS elements), for example, to reduce pilot overhead and/or channel estimation complexity.

The RIS system described above with reference to equations 1-6 may be used to illustrate sub-surface based RIS operations. Let Γⱼ denote a set of RIS element indices in the j:th sub-surface, with j=1, . . . , S. The union of sub-surfaces may include multiple (e.g., all) of the RIS element indices, e.g., ∪ⱼΓⱼ)={1, . . . , M}, and the sub-surface sets may be disjoint. Let γⱼ be an M×1 vector with ones on the rows given by the indices in Γⱼ, and zeroes elsewhere (e.g., the row indexing may start at 1). The RIS elements in γⱼ may be selected corresponding to the j:th sub-surface.

Let G=[γ₁ . . . γ_{S}] be a sub-surface selection matrix of dimension M×S. Equation 3 described above (e.g., which may represent an RIS system model) may be written as Equation 7 below:

$$y = ( c G {Φ}^{s} + d ) s + z = ( {c}^{s} {Φ}^{s} + d ) s + z \qquad ( 7 )$$

wherein Φ^{s} may represent a complex-valued vector of dimension S×1 including the S sub-surface factors

$${ϕ}_{j}^{s} ,$$

factor

$${ϕ}_{j}^{s}$$

may be applied to the RIS elements in γⱼ

$$( e . g . , {ϕ}_{m} = {ϕ}_{j}^{s} ∀ m ∈ {Γ}_{j} ) ,$$

and the same RIS element factor

$${ϕ}_{j}^{s}$$

may be applied to an (e.g., each) element in the j:th sub-surface. c^{s}=cG may represent a 1×S dimensional vector including S RIS-reflected aggregate channels per sub-surface (e.g., the j:th element of c^{s} may be equal to

$${\sum }_{{Γ}_{j}} {c}_{m} ) .$$

The term (c^{s}Φ^{s}+d) in Equation 7 may have the same form as the term (cΦ+d) in Equation 3, except for the length of the vectors, which may be S in the former (e.g., representing the number of sub-surfaces) and M in the latter (e.g., representing the number of RIS elements). A (e.g., any) method for channel estimation that may be applicable to a per-RIS-element operation may also be applicable to a per-sub-surface operation, and vice versa. For example, RIS channel estimation (e.g., per-RIS-element channel estimation) as described herein may be (e.g., directly) applicable to per-sub-surface channel estimation by changing the problem dimension (e.g., adding an s superscript). For example, h=[d c^{s}] may be used to represent a 1×(S+1) vector corresponding to a direct channel and S channels via RIS sub-surfaces, and Θ may be adapted to

$$Θ = [ \begin{matrix}1 & 1 & … & 1 \\ {Φ}_{0} & {Φ}_{1}^{s} & … & {Φ}_{S}^{s}\end{matrix} ]$$

where

$${Φ}_{i}^{s}$$

may represent an S×1 vector of RIS sub-surface factors during an i:th pilot symbol, and Θ may be a square matrix with a dimension of (S+1)×(S+1).

For the S sub-surfaces, S+1 pilots (e.g., reference signals or reference signal resources) may be used to estimate the cascaded channels associated with the S sub-surfaces. For example, a WTRU may estimate the cascaded channels according to Equation 8 below:

$$y = h Θ s + z \qquad ( 8 )$$

wherein y=[y₀ . . . y_{S}] may represent S+1 received pilot symbols, h=[d c^{s}] may represent a (1×(S+1) vector with a direct channel and S channels associated with the S sub-surfaces, and z=[z₀ . . . z_{S}] may represent a 1×(S+1) vector associated with the noise and/or interference received via the RIS.

Based on the equation above, with Θ as a full rank matrix that may be known to the WTRU, the WTRU may estimate the channels based on the received pilots y (e.g., as illustrated by Equation 5 or using other suitable techniques). For example, in the on-off method described herein, RIS sub-surfaces (e.g., all RIS sub-surfaces) may be turned off in a first step

$$( e . g . , {Φ}_{0}^{s} = 0 or {Φ}_{0}^{s} \approx 0 )$$

to acquire direct link coefficients during a first pilot symbol transmission (e.g., resulting in a received symbol). From a second pilot symbol onwards (i=1, . . . , S), a (e.g., one) sub-surface may be turned on, while other sub-surfaces may remain in the off state. As such, the j:th received pilot as reflected by the j-th sub-surface may be illustrated by Equation 6, with i=1, . . . , S.

In the sub-surface-based techniques described herein, if element-wise channel gain acquisition is performed within a (e.g., each) sub-surface, the sub-surface based estimation may be same as an element-wise channel estimation (e.g., using M+1 pilot symbols). In the case of a rectangular RIS with uniform sub-surfaces, if the number of sub-surfaces in a horizontal direction is denoted as Sₓ and the number of sub-surfaces in a vertical direction is denoted as S_{y}, S may be equal to Sₓ*S_{y}.

Sub-surface configurations may be scenario-dependent. A WTRU may obtain a suitable phase configuration (e.g., an RIS state) for a (e.g., each) sub-surface implicitly or explicitly, for example, as part of CSI acquisition. RIS elements may be provided with a certain phase configuration that may enable desired performance gains in RIS-aided communication (e.g., to achieve directional beamforming). Phase configurations among adjacent RIS elements may be correlated (e.g., to some degree) and may not be completely independent or uncorrelated. A positive correlation coefficient between two variables may signify that the variables may be moving in the same direction and highly correlated (e.g., as compared to zero or negative correlation coefficients). In examples, it may be assumed that phase configurations among adjacent RIS sub-surfaces may be correlated. The correlation coefficient ρᵢⱼ among two adjacent RIS sub-surfaces i and j may be given as in Equation 9 below:

$${ρ}_{i j} = \frac{cov ( {h}_{t} , {h}_{j} )}{{σ}_{{h}_{i}} {σ}_{{h}_{j}}} \qquad ( 9 )$$

wherein cov (hᵢ, hⱼ) may represent the covariance between variables hᵢ and hⱼ such that cov (hᵢ, hⱼ)= [symbol] ((hᵢ−μₕ_{ᵢ})((hᵢ−μₕ_{ⱼ})), with [symbol] (·) representing an expectation operator, (μₕ_{ᵢ}, μₕ_{ⱼ}) and (σₕ_{ᵢ}, σₕ_{ⱼ}) representing the mean and standard deviation of the variables (hᵢ, hⱼ), respectively.

Variation in the correlation coefficients across different RIS sub-surfaces may be utilized to determine the effect of an operational environment or setting (e.g., user mobility, blockages etc.), and/or to select a sub-surface level RIS configuration. For example, when a WTRU is moving in a horizontal plane, the RIS phase configuration among horizontally separated sub-surfaces may be more sensitive to phase changes (e.g., as compared to sub-surfaces separated vertically). This may result in higher ρᵢⱼ in the horizontal direction (e.g., as compared to moving across the vertical direction). Based on the changes in the sub-surface configuration, the WTRU may report the sub-surface correlation, which may be used to update an RIS state and/or the sub-surface configuration itself. In the case where multiple WTRUs are assisted by an RIS and each WTRU is served by a different or same set of sub-surfaces, the sub-surface configuration may be determined based on the respective operational scenarios of the WTRUs. For example, when different WTRUs are in different vertical angles, the sub-surfaces as illustrated in FIG. 7A may be considered, whereas if the WTRUs are moving in the same vertical angle, configurations based on sub-surfaces distributed according to FIG. 7B may be considered (e.g., to achieve enhanced performance gains).

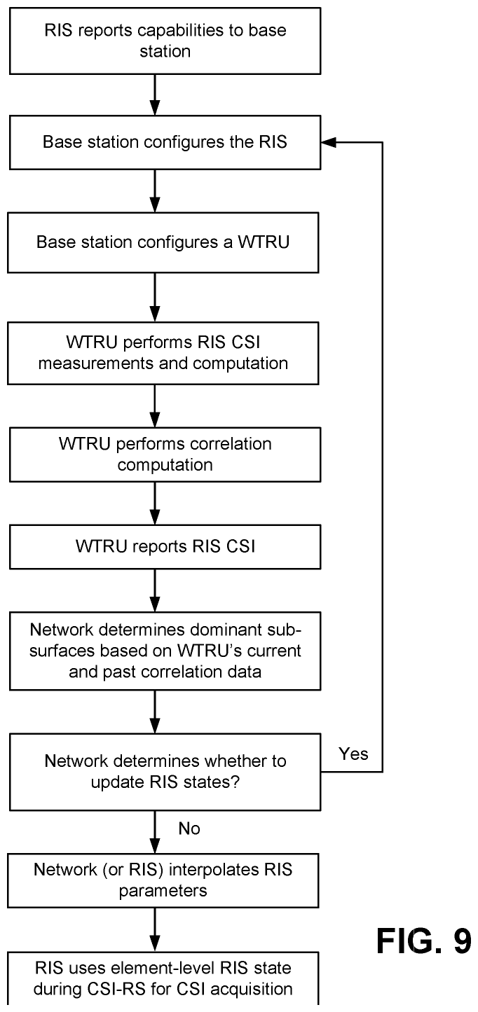

FIG. 9 illustrates an example procedure associated with scenario-dependent sub-surface configurations. The procedure may involve a base station, an RIS, and/or one or more WTRUs. The RIS may be partitioned into sub-surfaces (e.g., as configured by the base station). A subset or all of the sub-surfaces may be activated and/or allocated to one or more WTRUs at a given time. The base station may configure the WTRUs and/or the RIS. The WTRUs may perform CSI acquisition and/or CSI measurements (e.g., for a direct path and/or an RIS-aided path) using CSI RS resources provided by the base station. The WTRUs may perform correlation computation across the sub-surfaces to determine (e.g., obtain) one or more dominant sub-surfaces. The WTRUs may report the RIS CSI (e.g., including an RIS-Quality Indicator (RIS-QI), correlation coefficients, phase-shift functions, etc.) at a per sub-surface level (e.g., each sub-surface may include one or more RIS elements). Using current and/or past RIS CSI reports from the WTRUs, the base station may identify one or more dominant sub-surfaces. Based on these reports, the base station may determine to update the sub-surface level settings at the RIS (e.g., number and/or location of sub-surfaces allocated to a user, multiplexing of transmissions associated with the sub-surfaces to more WTRUs, etc.). The base station may (e.g., in response to the determination) reconfigure the RIS and/or update one or more of the WTRUs with new or updated RIS configuration information. The base station and/or the RIS may interpolate a sub-surface level RIS state to an element-wise RIS state based on RIS phase shifts (e.g., RIS phase shift functions) reported by the WTRUs. These interpolated RIS states may be used by the RIS, for example, to provide CSI-RS resources for a CSI acquisition task.

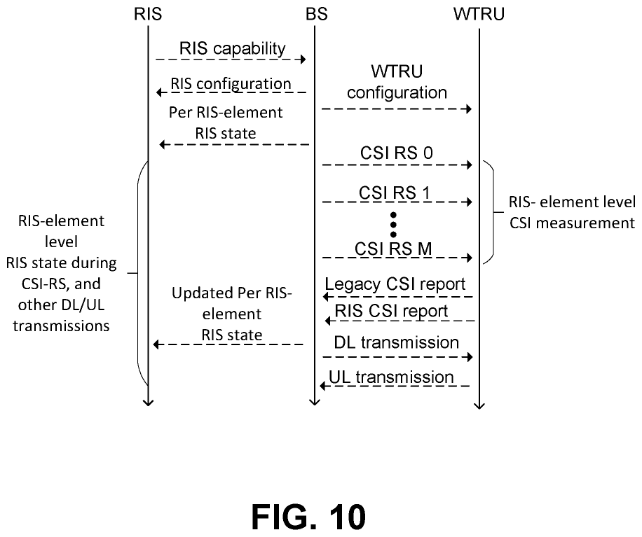

An RIS may be configured at an element level (e.g., on a per-element basis) or a sub-surface level (e.g., on a per-sub-surface basis) based on the capabilities of the RIS. As such, if CSI acquisition is performed at a per-element level for M RIS elements, there may be M+1 pilot transmissions. FIG. 10 illustrates message exchange associated with element-wise RIS operations. As shown, an RIS and a WTRU may be configured by a network such as a base station (BS). The WTRU may perform measurements using available CSI-RS resources. Based on the CSI-RS resources, the WTRU may determine (e.g., acquire) CSI for a direct path (e.g., a path from the base station to the WTRU, without reflection of the RIS) and/or an RIS-aided path (e.g., a path from the base station to the RIS and then to the WTRU). The WTRU may perform the measurements and report element-wise results (e.g., in a legacy CSI report or an additional RIS CSI report). Based on the report(s) from the WTRU, the base station may configure the RIS with an updated RIS state. DL and/or UL transmissions may then be performed based on the reporting and/or the updated (or the original) RIS states.

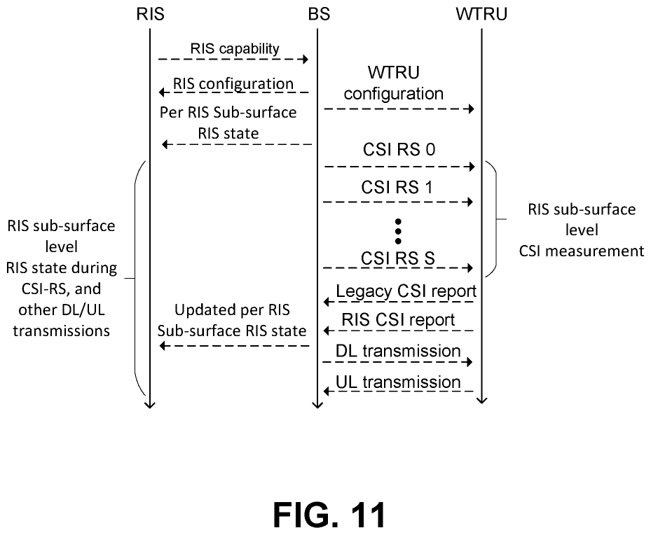

If an RIS surface is partitioned into S sub-surfaces, sub-surface level CSI acquisition may be performed using S+1 CSI-RS resources (e.g., S+1 reference signal transmissions). Signaling overhead associated with the sub-surface level CSI acquisition may be reduced by M/S (e.g., as compared to the element-wise CSI acquisition). FIG. 11 illustrates examples of sub-surface level RIS signaling.

In examples (e.g., in the case of uniform element distribution per sub-surface), the total number of sub-surfaces may inversely depend on the number of elements in each sub-surface. The fewer RIS elements included in a sub-surface, the greater the number of sub-surfaces may be, and vice-versa. Increasing the number of sub-surfaces may be costly as it may increase the overhead for signaling related to CSI feedback. On the other hand, the performance of a communication system may degrade in some aspects if a large number of elements is included in a sub-surface (e.g., compared to performance that may be achievable with smaller sub-surfaces or element-wise CSI acquisition). The resolution of an achievable phase (e.g., a number of bits representing a phase configuration in case of discrete phase-shifters) at an element level or a sub-surface level may affect overall communication performance. A smaller phase resolution may introduce quantization errors and lead to degraded performance. On the other hand, because of the smaller number of bits used per phase configuration, a smaller phase resolution may lead to less signaling overhead. As such, sub-surface dimension and/or phase resolution may be parameters that may be controlled to improve RIS-aided communication performance and/or to reduce signaling overhead. A WTRU may recommend to the network a desirable size or dimension of a sub-surface and/or a phase resolution to achieve a target performance (e.g., in terms of SINR, BLER, etc.). For example, if the target performance is not achieved by the WTRU, the WTRU may request a change (e.g., an increase) to the granularity of sub-surfaces (e.g., by decreasing the size or number elements of one or more sub-surfaces), or a change (e.g., an increase) to the phase resolution at an RIS element level or sub-surface level (e.g., based on a predefined configuration). An achievable phase resolution may not be infinite and may be limited by hardware constraints. If an RIS is already configured at the maximum possible phase resolution, a base station (BS) may increase the granularity of sub-surfaces by reducing the size of the sub-surfaces until an element-wise RIS configuration is achieved. If an element-wise granularity is already achieved and the WTRU requests further performance improvement, the phase resolution per RIS element may be increased, for example, until a highest possible phase resolution is achieved.

CSI-RSs may be used for a wide range of purposes, such as beam management, mobility, time-frequency tracking, CSI acquisition, etc. The configuration and transmission of CSI-RSs may be performed in a wide range of use cases. Various CSI-RS transmission schemes and corresponding configurations may be applied to RIS CSI determination. One or more CSI-RSs may be provided for RIS sub-surfaces.

An RIS element may be in a state (e.g., a single state) at a time. An RIS element factor (e.g., a single RIS element factor) may be used during a certain time duration such as an OFDM symbol. The RIS element factor of an RIS element may be changed between time durations (e.g., between symbols). There may be a transient time associated with an RIS element factor change, which may be shorter than an OFDM cyclic prefix. The RIS state of an RIS element at a given time (e.g., the RIS state in an OFDM symbol) may be used for CSI measurement and/or reporting. Pilots (e.g., reference signals) may be time-division multiplexed (e.g., rather than frequency- or code-division multiplexed) such that multiple pilots with different RIS states may be transmitted or received. This may create a constraint on the operation of an RIS, including CSI determination and/or RIS adjustments.

A CSI-RS may be used as a pilot for RIS channel estimation and/or CSI acquisition. In examples, M+1 CSI-RS resources may be used to determine CSI associated with an RIS, where M may be the number of sub-surfaces (or RIS elements in some examples) of the RIS. The extra resource (e.g., the 1 in M+1) may be used to estimate a direct path or channel (e.g., between a base station and a WTRU, not aided by an RIS). In examples, the M+1 CSI-RS resources may be included in a CSI-RS resource set. In examples, the M+1 CSI-RS resources may be included in multiple CSI-RS resource sets. The CSI-RS resources may be single-port or multi-port resources (e.g., dual-port resources).

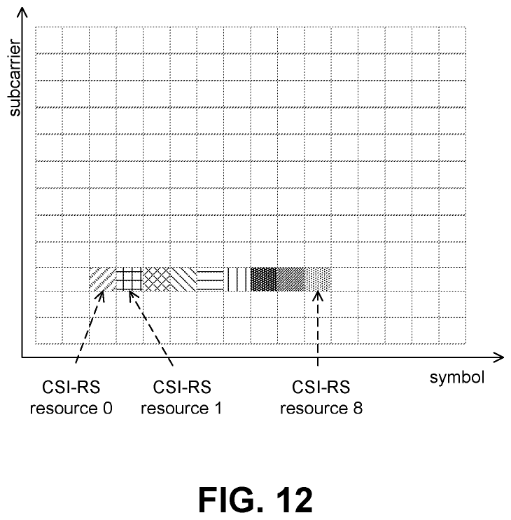

FIG. 12 illustrates examples of single-port CSI-RS resources within a resource block (RB) (e.g., of a 14-symbol slot). In the examples of FIG. 12, the CSI-RS resources may have the same sub-carrier offset. In other examples, different CSI-RS resources may have different sub-carrier offsets. Further, different CSI-RS resources may have the same or different frequency density, the same or different bandwidth, the same or different number of antenna ports, the same or different code-division multiplexing (CDM) type, etc. The periodicity of the CSI-RS resources may also be the same or different. The slot offsets of the CSI-RS resources may also be the same or different. A constraint may be imposed such that the CSI-RS resources may not overlap in time on a symbol (e.g., on any symbol).

The M+1 CSI-RS resources associated with the RIS may be associated with similar (but not the same) transmission times such as, for example, consecutive symbols, a same slot, consecutive slots, etc. in order to enable timely and relevant CSI measurement and reporting. M of the M+1 CSI-RS resources may correspond to per sub-surface (or, in some cases, per RIS element) channel estimation, whereas the remaining CSI-RS resource may correspond to the estimation of a direct path or channel (e.g., this resource may be referred to herein as a direct CSI-RS resource). A WTRU may determine which CSI-RS resource in a CSI-RS resource set may be the direct CSI-RS resource using one or more of the techniques described below.

In examples, the CSI-RS resources in a CSI-RS resource set may be configured as a list (e.g., using a list of CSI-RS resource IDs) and a direct CSI-RS resource may have a certain ordinal position in the list. For example, the direction CSI-RS resource may be the first resource in the list or the last resource in the list. In examples, the CSI-RS resources in a CSI-RS resource set may have different CSI-RS resource IDs and a direct CSI-RS resource may be the CSI-RS resource with the lowest ID, the highest ID, etc. In examples, the CSI-RS resources in a CSI-RS resource set may be ordered in time (e.g., if they occur in the same slot or in a number of consecutive slots) and a direct CSI-RS resource may be the CSI-RS resource having a certain ordinal position in time. For example, the direct CSI-RS resource may be the resource first in time (e.g., with the lowest slot offset plus a symbol offset), the resource last in time, the resource in the middle (e.g., with M/2 resources before it and M/2 resources after it), etc.

A CSI-RS resource may be configured such that a WTRU may determine whether or not the CSI-RS resource is a direct CSI-RS resource if the CSI-RS resource is included in a CSI-RS resource set configured for RIS CSI determination. A constraint may be imposed on the configuration of the CSI-RS resource in the CSI-RS resource set to allow the WTRU to determine whether the CSI-RS resource is a direct CSI-RS resource. For example, a direct CSI-RS resource may be configured with a different (e.g., higher) density, a different (e.g., higher) power offset, and/or a different (e.g., shorter) periodicity than the other CSI-RS resources in the CSI-RS resource set.

In examples, a direct CSI-RS resource may be placed or scheduled near the middle (e.g., in terms of time) of a resource set since the accuracy of CSI estimation may increase with a smaller time difference between the direct CSI-RS resource and the other (e.g., M) CSI-RS resources. For example, in FIG. 12, CSI-RS resource 4 may be a direct CSI-RS resource.

In examples, a direct CSI-RS resource may not be in the same resource set as the other (e.g., M) CSI-RS resources (e.g., the other resources may be included in one or multiple CSI-RS resource sets), but the CSI-RS resource set containing the direct CSI-RS resource may be associated with the CSI-RS resource set(s) containing the other M CSI-RS resources. In examples, CSI-RS resource set(s) that may include the M+1 CSI-RS resources may be configured (e.g., by their IDs) in a CSI-RS resource setting (e.g., in an IE named CSI-ResourceConfig). Such a CSI-RS resource setting may include a list of CSI-RS resource sets, for example, for channel measurement. The list of CSI-RS resource sets may include a sequence of CSI-RS resource set IDs of the CSI-RS resource sets, which may be configured separately (e.g., with another IE). In examples, a direct CSI-RS resource may be included in a resource set with a certain ordinal position in the list of CSI-RS resource sets (e.g., as the first set or the last set in the list). In examples, a direct CSI-RS resource may be included in a CSI-RS resource set with the lowest (or the highest) CSI-RS resource set ID. In examples, a CSI-RS resource set may be configured such that a WTRU may determine that the resource set includes a direct CSI-RS resource. For example, configuration information for a CSI-RS resource set may include a parameter that may indicate if the resource set includes a direct CSI-RS resource. In examples, a CSI-RS resource set that includes a direct CSI-RS resource may be configured with a certain combination of parameters (e.g., the resource set may include a single CSI-RS resource and have a repetition parameter set to “on”).

In examples, M single-port CSI-RS resources may be used to estimate M RIS-aided channels. In examples, one or more multi-port CSI-RS resources may be used to estimate the M RIS-aided channels. In the latter examples, a direct path or channel may be estimated based on a port of the one or more multi-port CSI-RS resources. This may result in an odd number (M+1) of antenna ports if the number of sub-surfaces is an even number. For simplicity, some examples provided herein may assume that a direct channel may be estimated from a separate CSI-RS resource, such as, e.g., a single-port CSI-RS resource.

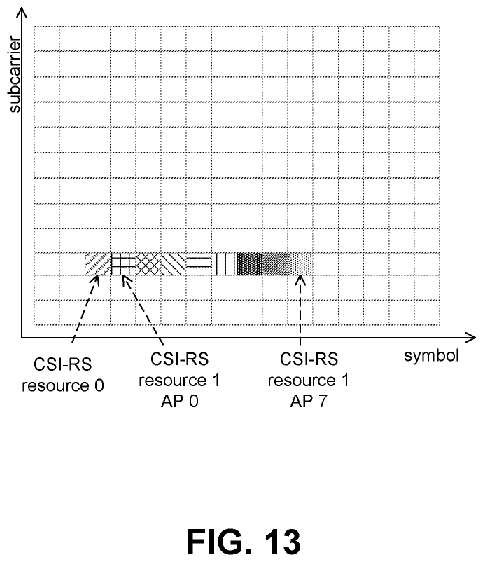

FIG. 13 illustrates an example of a single port CSI-RS resource and an example of an 8-port CSI-RS resource.

A legacy communication system may not support pure time-division multiplexing (TDM) of antenna ports within one multi-port CSI-RS resource. Table 1 below shows example entries (e.g., rows 19-24) that may correspond to various number of antenna ports and various TDM patterns. Rows 1-18 in the table may be used for a legacy system and are repeated here for comparison.

TABLE 1
Example CSI-RS locations within a slot

| | Ports | Density | | | CDM group | | |
|---|---|---|---|---|---|---|---|
| Row | X | ρ | cdm-Type | (k̅, l̅) | index^{j} | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₀, l₀ + 1), | 0, 1, 2, 3 | 0, 1 | 0 |
| | | | | (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), | 0, 1, 2, 3, | 0, 1 | 0 |
| | | | | (k₃, l₀), (k₄, l₀), (k₅, l₀) | 4, 5 | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), (k₁, l₀ + 1), | 4, 5, 6, 7 | | |
| | | | | (k₂, l₀ + 1), (k₃, l₀ + 1) | | | |
| 12 | 16 | 1, 0.5 | cdm4-FD2- | (k₀, l₀), (k₁, l₀), (k₂, l₀), (k₃, l₀) | 0, 1, 2, 3 | 0, 1 | 0, 1 |
| | | | TD2 | | | | |
| 13 | 24 | 1, 0.5 | fd-CDM2 | (k₀, l₀), (k₁, l₀), (k₂, l₀), (k₀, l₀ + 1), | 0, 1, 2, 3, | 0, 1 | 0 |
| | | | | (k₁, l₀ + 1), (k₂, l₀ + 1), (k₀, l₁), | 4, 5, 6, 7, | | |
| | | | | (k₁, l₁), (k₂, l₁), (k₀, l₁ + 1), | 8, 9, 10, 11 | | |
| | | | | (k₁, l₁ + 1), (k₂, l₁ + 1) | | | |
| 14 | 24 | 1, 0.5 | cdm4-FD2- | (k₀, l₀), (k₁, l₀), (k₂, l₀), (k₀, l₁), | 0, 1, 2, 3, | 0, 1 | 0, 1 |
| | | | TD2 | (k₁, l₁), (k₂, l₁) | 4, 5 | | |
| 15 | 24 | 1, 0.5 | cdm8-FD2- | (k₀, l₀), (k₁, l₀), (k₂, l₀) | 0, 1, 2 | 0, 1 | 0, 1, |
| | | | TD4 | | | | 2, 3 |
| 16 | 32 | 1, 0.5 | fd-CDM2 | (k₀, l₀), (k₁, l₀), (k₂, l₀), (k₃, l₀), | 0, 1, 2, 3, | 0, 1 | 0 |
| | | | | (k₀, l₀ + 1), (k₁, l₀ + 1), | 4, 5, 6, 7, | | |
| | | | | (k₂, l₀ + 1), (k₃, l₀ + 1), (k₀, l₁), | 8, 9, 10, | | |
| | | | | (k₁, l₁), (k₂, l₁), (k₃, l₁), (k₀, l₁ + 1), | 11, 12, 13, | | |
| | | | | (k₁, l₁ + 1), (k₂, l₁ + 1), (k₃, l₁ + 1) | 14, 15 | | |
| 17 | 32 | 1, 0.5 | cdm4-FD2- | (k₀, l₀), (k₁, l₀), (k₂, l₀), (k₃, l₀), | 0, 1, 2, 3, | 0, 1 | 0, 1 |
| | | | TD2 | (k₀, l₁), (k₁, l₁), (k₂, l₁), (k₃, l₁) | 4, 5, 6, 7 | | |
| 18 | 32 | 1, 0.5 | cdm8-FD2- | (k₀, l₀), (k₁, l₀), (k₂, l₀), (k₃, l₀) | 0, 1, 2, 3 | 0, 1 | 0, 1, |
| | | | TD4 | | | | 2, 3 |
| 19 | 2 | 1, 0.5 | TD2 | (k₀, l₀), (k₀, l₀ + 1) | 0, 0 | 0 | 0 |
| 20 | 4 | 1, 0.5 | TD4 | (k₀, l₀), (k₀, l₀ + 1), (k₀, l₀ + 2), | 0, 0, 0, 0 | 0 | 0 |
| | | | | (k₀, l₀ + 3) | | | |
| 21 | 8 | 1, 0.5 | TD8 | (k₀, l₀), (k₀, l₀ + 1), (k₀, l₀ + 2), | 0, 0, 0, 0, | 0 | 0 |
| | | | | (k₀, l₀ + 3), (k₀, l₀ + 4), (k₀, l₀ + 5), | 0, 0, 0, 0 | | |
| | | | | (k₀, l₀ + 6), (k₀, l₀ + 7) | | | |
| 22 | 2 | 1, 0.5 | TD2 | (k₀, l₀), (k₀, l₀ + 2) | 0, 0 | 0 | 0 |
| 23 | 4 | 1, 0.5 | TD4 | (k₀, l₀), (k₀, l₀ + 1), (k₀, l₀ + 3), | 0, 0, 0, 0 | 0 | 0 |
| | | | | (k₀, l₀ + 4) | | | |
| 24 | 8 | 1, 0.5 | TD8 | (k₀, l₀), (k₀, l₀ + 1), (k₀, l₀ + 2), | 0, 0, 0, 0, | 0 | 0 |
| | | | | (k₀, l₀ + 3), (k₀, l₀ + 5), (k₀, l₀ + 6), | 0, 0, 0, 0 | | |
| | | | | (k₀, l₀ + 7), (k₀, l₀ + 8) | | | |
| 25 | 2 | 1, 0.5 | TD2 | (k₀, l₀), (k₀, l₁) | 0, 0 | 0 | 0 |
| 26 | 4 | 1, 0.5 | TD4 | (k₀, l₀), (k₀, l₀ + 1), (k₀, l₁), | 0, 0, 0, 0 | 0 | 0 |
| | | | | (k₀, l₁ + 1) | | | |
| 27 | 8 | 1, 0.5 | TD8 | (k₀, l₀), (k₀, l₀ + 1), (k₀, l₀ + 2), | 0, 0, 0, 0, | 0 | 0 |
| | | | | (k₀, l₀ + 3), (k₀, l₁), (k₀, l₁ + 1), | 0, 0, 0, 0 | | |
| | | | | (k₀, l₁ + 2), (k₀, l₁ + 3) | | | |

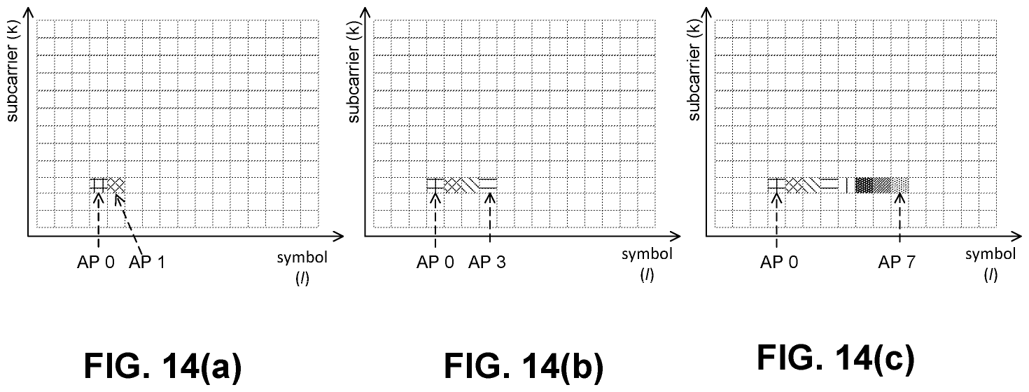

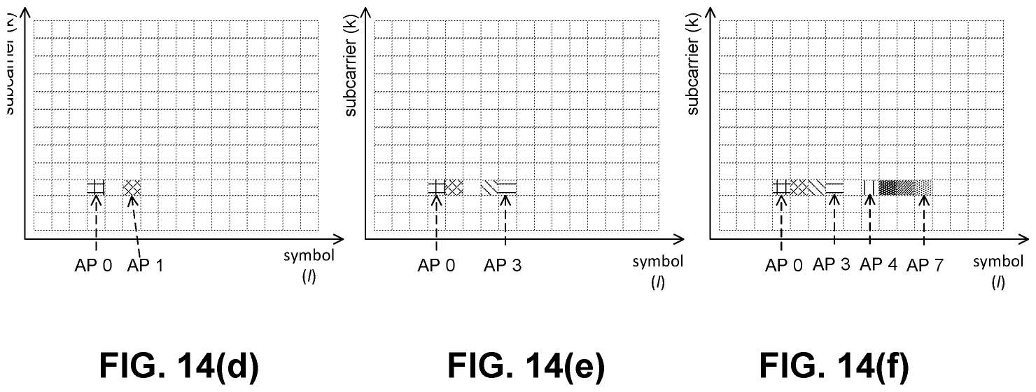

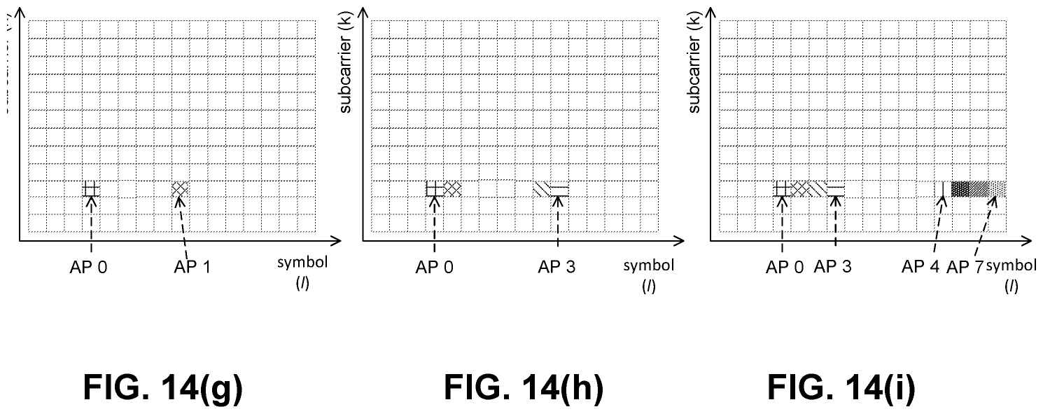

FIGS. 14(a)-(i) illustrates examples of TDM'ed antenna ports (AP) of a multi-port CSI-RS. FIGS. 14(a), 14(b) and 14(c) show 2/4/8-port CSI-RS resources with the antenna ports in consecutive symbols, which may correspond to rows 19/20/21 in Table 1, respectively, with k_0=2 and l_0=3. FIGS. 14(d), 14(e) and 14(f) show 2/4/8-port CSI-RS resources with a single gap symbol, which may correspond to row 22/23/24 in Table 1, with k_0=2 and l_0=3. FIGS. 14(g), 14(h) and 14(i) show 2/4/8-port CSI-RS resources with two configurable starting symbols (k_0 and k_1). FIG. 14(g) may correspond to row 25 in Table 1, with k_0=2, k_1=8, and l_0=3, FIG. 14(h) may correspond to row 26 in Table 1, with k_0=2, k_1=9, and l_0=3, and FIG. 14(i) may correspond to row 27 in Table 1, with k_0=2, k_1=12, and l_0=3.

Gap symbols may allow the transmission of a direct CSI-RS resource in a gap, which may improve the overall channel and CSI estimation performance in mobile scenarios. The gap symbols may be used to allow a network to multiplex other transmissions in the gap, such as SSBs or urgent PDCCH/PDSCH transmissions.

Multiple multi-port CSI-RS resources may be provided for RIS related CSI determination. For example, two or more (e.g., all) of the M+1 (or M in some cases) CSI-RS resources described herein may be multi-port CSI-RS resources. In examples, the multi-port CSI-RS resources may be configured similarly in terms of frequency domain allocation (e.g., which sub-carriers within a PRB may be used for the CSI-RS resources), bandwidth, density, number of antenna ports, code-division multiplexing (CDM) type, etc. For example, the configuration of the multi-port CSI-RS resources may correspond to a same row in Table 1. In examples, the multi-port CSI-RS resources may be configured differently in one or more of the aforementioned aspects. In examples, the multiple ports of a CSI-RS resource may span one or more symbols. For such a multi-symbol multi-port CSI-RS resource, an RIS may apply the same RIS state during the multiple symbols associated with the CSI-RS resource. The RIS may do so, for example, if the antenna ports associated with the CSI-RS resource span multiple symbols (e.g., for one or more rows in Table 1 with a cdm-type of TD2, TD4, etc.). In examples, different RIS states may be applied during different symbols of a multi-symbol multi-port CSI-RS resource if different sets of ports are TDM'ed (e.g., for one or more rows in Table 1 with a cdm-type other than TD2 or TD4).

Multiple (e.g., N_{T}) antenna ports of a CSI-RS resource may be associated with the same RIS state Φᵢ (or

$${Φ}_{i}^{s}$$

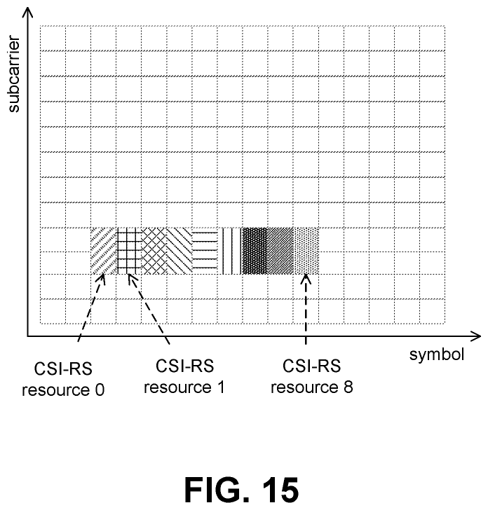

in case of sub-surfaces). Such a col-RS resource may have a configuration according to row 3 in Table 1 (e.g., 2 antenna ports multiplexed in the same symbol), as illustrated in FIG. 15. This may mean that a WTRU may estimate N_{T} (e.g., 2) different sets of channels per RIS state and/or per pair of adjacent sub-carriers carrying the CSI-RS resource.

M+1 (or S+1 in case of sub-surfaces) TDM'ed CSI-RS resources may be used to estimate M+1 (or S+1 in case of sub-surfaces) channels per CSI-RS antenna port. A WTRU may take the k:th antenna port (k∈{0 . . . (N_{T}−1)}) from each of the M+1 (or S+1) N_{T}-port CSI-RS resources and perform channel estimation as described herein (e.g., in accordance with Equation 5).

The following explanation may be provided in the context of an RIS-element level model or operation, but may also be applicable to a sub-surface level model or operation. If TRP precoding P is not included in a TRP-to-RIS path or channel, Equation 3 described above may be written as Equation 10 below:

$$y = ( ( a ⊙ b ) Φ + d ) s + z = ( ( {( AP )}^{T} b ) Φ + {d}^{′} P ) s + z = ( {( ( A ⊙ {b}^{T} ) P )}^{T} Φ + {d}^{′} P ) s + z \qquad ( 10 )$$

wherein a=(AP)^{T} may be a complex-valued vector channel of dimension 1×M between the TRP and the RIS, and M may be the number of RIS elements, including the TRP precoding P.

$$A = [ \begin{matrix}{a}_{1}^{′} \\ ⋮ \\ {a}_{M}^{′}\end{matrix} ] = [ \begin{matrix}{a}_{0}^{″} & … & {a}_{{N}_{T} - 1}^{″}\end{matrix} ]$$

may be a complex-valued M×N_{T} channel matrix between the TRP and the RIS (e.g., excluding TRP precoding). The m:th row and k:th column in the matrix may be denoted as

$${a}_{m}^{′} and {a}_{k}^{″} ,$$

respectively, where the meaning of

$${a}_{m}^{′}$$

may be as described herein.

$$A ⊙ {b}^{T} = [ \begin{matrix}{a}_{1}^{′} {b}_{1} \\ ⋮ \\ {a}_{M}^{′} {b}_{M}\end{matrix} ]$$

may be a cascaded RIS-aided channel matrix of dimension M×N_{T} along a TRP-RIS-WTRU path, excluding RIS element factors, wherein the meaning of bₘ may be as described herein. P as shown in the equation may be a complex-valued N_{T}×1 precoding vector. In examples, P may be a complex-valued N_{T}×N_{L} precoding matrix corresponding to N_{L} layers. In those examples, s may be an N_{L}×1 symbol vector (e.g., rather than a scalar). For simplicity of description, the examples provided herein may be described as having a precoding vector P.

The M+1 pilot symbols received on the k:th CSI-RS antenna port may be satisfy Equation 11 below (e.g., following Equation 4 described above). CSI-RS antenna ports on adjacent sub-carriers or within an RB may be considered, which may allow for an assumption or an approximation that the radio channels may be the same across the REs carrying the different CSI-RS antenna ports.

$${y}_{k} = {h}_{k} Θ s + {z}_{k} = [ ( {d}^{′} {P}_{k} ) ( {( A {P}_{k} )}^{T} ⊙ b ) ] Θ s + {z}_{k} = {( [ \begin{matrix}{d}^{′} \\ A ⊙ {b}^{T}\end{matrix} ] {P}_{k} )}^{T} Θ s + {z}_{k} \qquad ( 11 )$$

wherein yₖ=[y_{k,0} . . . y_{k,M}] may be the M+1 received pilot symbols on CSI-RS antenna port k, hₖ=[dₖ cₖ]=[(d′Pₖ) ((AₖPₖ)^{T}⊙b)] may be a 1×(M+1) vector with a direct channel and M RIS-aided channels on CSI-RS antenna port k, and d′ may be a 1×N_{T} direct channel from the TRP to the WTRU. Pₖ may be a N_{T} precoding vector applied to CSI-RS antenna port k. For instance, for TRP antenna selection across the N_{T} TRP antennas, antenna selection precoders may be applied to the different CSI-RS antenna ports with the k:th element being 1 and the rest being 0 (e.g., P₀=[1 0 . . . 0]^{T}, P₁=[0 1 0 . . . 0]^{T}, etc.). When used herein, an TRP antenna may be interpreted broadly. It may, for instance, correspond to a set of antennas elements connected to a transceiver chain through a set of splitters and phase shifters. A same precoders Pₖ may be applied to the antenna ports of the M+1 different CSI-RS resources.

$$Θ = [ \begin{matrix}1 & … & 1 \\ {Φ}_{0} & … & {Φ}_{M}\end{matrix} ]$$

may be a square matrix with dimension (M+1)×(M+1) containing the RIS element factors. The same matrix Θ may be applied to multiple (e.g., all) antenna ports. zₖ=[z_{k,0} . . . z_{k,M}] may be a vector of dimension 1×(M+1) that may be associated with the noise and interference received on the k:th CSI-RS antenna port.

For simplicity of notation, s may be used to represent the symbol(s) on CSI-RS antenna port k. For different pilots in time, pilot symbol s may be different on different antenna ports (e.g., as long as the symbol is known by the WTRU, for example, via a known sequence of pilots or reference symbols). In those cases, notations sₖ, s_{m,k}, or s_{j,k} may be used instead.

With the antenna selection precoders described herein, Equation 11 may be reduced to Equation 12 below:

$${y}_{k} = {h}_{k} Θ s + {z}_{k} = [ \begin{matrix}{d}_{k}^{′} & {a}_{k}^{″ T} ⊙ b\end{matrix} ] Θ s + {z}_{k} \qquad ( 12 )$$

wherein

$${d}_{k}^{′}$$

may represent a direct scalar channel or path from the k:th TRP antenna to the WTRU, and

$${a}_{k}^{″}$$

may be a 1×M vector associated with the channel between the k:th TRP antenna and the M RIS elements.

For simplicity of description, index k may denote the CSI-RS antenna port and TRP antenna (e.g., due to the antenna selection precoders described herein). Other mappings between one or more TRP antennas and a CSI-RS antenna port may be achieved with a different selection of precoders Pₖ. For example, the WTRU may estimate the channels (e.g., including direct and/or RIS-aided channels) from the TRP to the WTRU per CSI-RS antenna port, which may correspond to a per TPR antenna estimation based on

$${h}_{k} = [ \begin{matrix}{d}_{k}^{′} & {a}_{k}^{″ T} ⊙ b\end{matrix} ] ,$$

where k=0, . . . , N_{T}. In examples, the following may be true,

$$[ \begin{matrix}{a}_{0}^{″ T} ⊙ b \\ ⋮ \\ {a}_{{N}_{T} - 1}^{″ T} ⊙ b\end{matrix} ] = A ⊙ {b}^{T} ,$$

and the WTRU may use the estimates of A⊙b^{T} and d′ to jointly optimize P and Φ in Equation 10. For example, the WTRU may select P and Φ such that |((A⊙b^{T})P)^{T}Φ+d′P| may be maximized (e.g., which may maximize a received power or SNR). Precoding P may affect the gains of a direct path (e.g., |d′P|) and/or the gains of the RIS-aided path (e.g., |((A⊙b^{T})P)^{T}Φ|). The RIS state Φ may (e.g., only) affect the gains of the RIS-aided path.

In examples, the WTRU may report a recommended precoder (e.g., P) and/or a recommended RIS state (e.g., ϕ) in a CSI report. The recommended precoder may be parameterized using various methods including various types of legacy PMI reporting methods (e.g., Type-I and Type-II codebooks, wideband- and sub-band PMI, etc.). The recommended RIS state may be parameterized using parameter set P as discussed herein.

The precoder and RIS state optimization and reporting described herein may be applicable to sub-surface based RIS operations. For example, for sub-surface based RIS operations, the description provided above may be adapted by using dimension S instead of M, and/or by using notations for sub-surface based operations such as Φ^{s} and

$${c}_{k}^{s} .$$

An RIS CSI-RS burst may be provided. This may be because reference signal transmissions in one slot may not be sufficient when the number of RIS element M is large. In those situations, RS transmissions may be performed over multiple slots, where the multiple slots may or may not be consecutive. A legacy communication system may support up to 8 CSI-RS resources in a CSI-RS resource set. This constraint may be used to limit WTRU CSI computational complexity and/or the number of bits for a CRI in a CSI report. For RIS CSI, the CSI complexity per CSI-RS resource may be lower for a WTRU (e.g., compared to other types of CSI reports), and/or an RIS CSI report may not include a CRI. AS such, an extended CSI-RS resource set (e.g., with more than 8 CSI-RS resources) may be supported for estimating M sub-surface based channels with M CSI-RS resources. The CSI-RS resources may be TDM'ed and/or the CSI-RS resources in the resource set may span multiple slots. The CSI-RS resources may be single- or multi-port resources, even though they may be shown as single-port CSI-RS resources in some figures provided herein.

CSI-RS resources (e.g., the M CSI-RS resources associated RIS CSI determination) may be split into multiple (e.g., Z) CSI-RS resource sets. The Z resource sets may be included or indicated in a CSI-RS resource setting or configuration. A CSI-RS resource set that includes a direct CSI-RS resource may be included in the CSI-RS resource setting or configuration.

In a legacy communication system, a CSI report may be generated and/or transmitted based on channel measurements performed using resources (e.g., CSI-RS or SSB) included in a CSI-RS resource set (e.g., such as a single CSI-RS resource set). For example, a CSI resource setting may include a single CSI-RS resource set for periodic and semi-persistent CSI reporting. As an enhancement, a CSI report may be generated based on resources included in multiple CSI-RS resource sets. A CSI resource setting may be configured with multiple CSI-RS resource sets, for example, for periodic and/or semi-persistent CSI reporting.

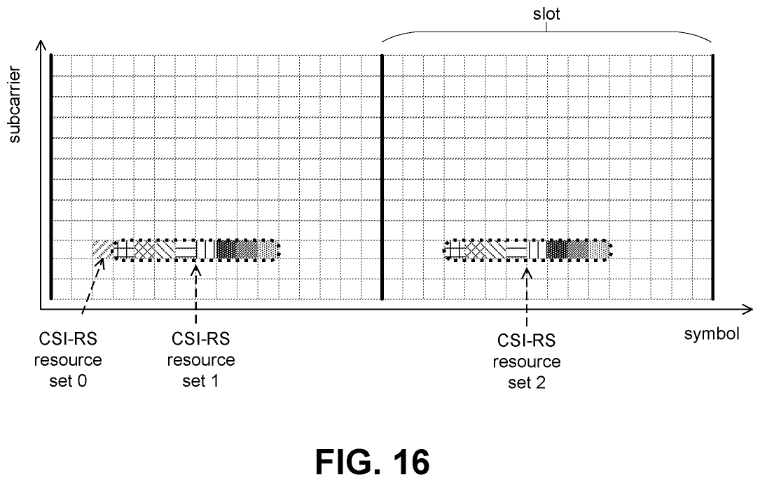

In examples, the CSI-RS resources in a CSI-RS resource set may be transmitted in the same slot, while CSI-RS resources in different resources sets of the same CSI resource setting may be transmitted in different slots. In examples, CSI-RS resources in different CSI-RS resource sets of the same CSI-RS resource setting may be transmitted in the same slot. FIG. 16 illustrates an example with two CSI-RS resource sets in the same slot and a third CSI-RS resource set in the following slot. In the example, CSI-RS resource set 0 may include a direct CSI-RS resource, while the other two resource sets (set 1 and 2) may include M CSI-RS resources (e.g., M=16) associated with an RIS.

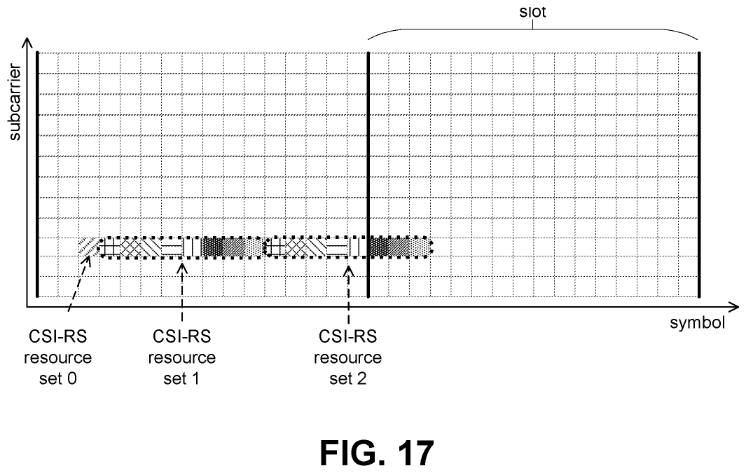

In examples, CSI-RS resources in different CSI-RS resource sets of the same CSI resource setting may be transmitted in the same slot or in different slots. FIG. 17 shows an example in which some CSI-RS resources of CSI-RS resource set 2 are transmitted in the same slot as the CSI-RS resources of another resource set of the same CSI resource setting, while other CSI-RS resources in CSI-RS resource set 2 may be transmitted in a different slot.

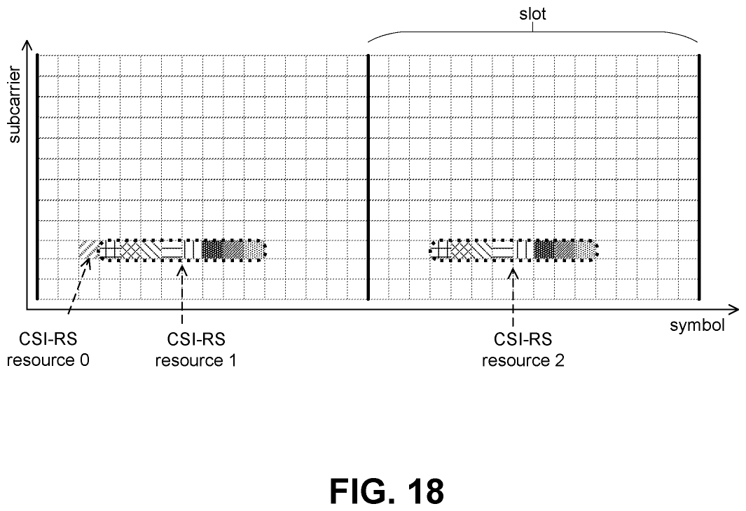

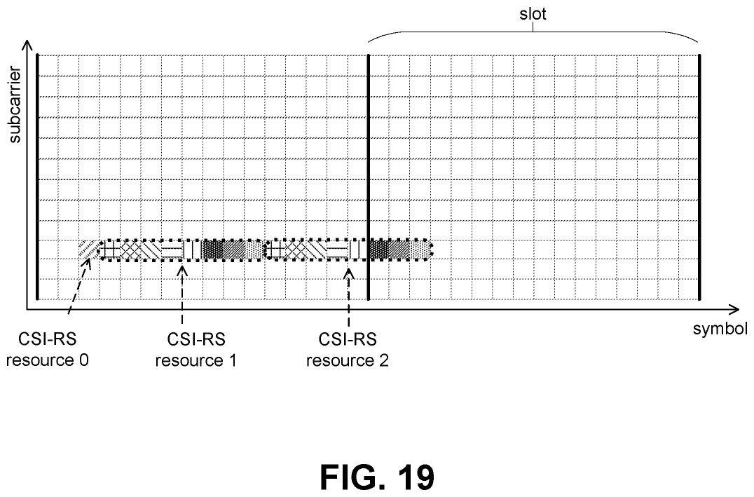

In examples, multi-port CSI-RS resources may be used for sub-surface based channel estimation. The number of pilots (e.g., M) may be higher than the number (e.g., maximum number) of TDM'ed CSI-RS antenna ports (e.g., the maximum number of TDM'ed antenna ports in the examples of Table 1 may be 8). For a value of M that is greater than 8, e.g., M=16, the number of pilots may be obtained across multiple multi-port CSI-RS resources. For example, two 8-port CSI-RS resources may provide sufficient pilots for M=16, as illustrated in FIG. 18 and FIG. 19. Like the multiple CSI-RS resource sets discussed herein, the multi-port CSI-RS resources may be in the same slot or different slots, as shown in FIG. 18. A multi-port CSI-RS resource may cross a slot boundary, as shown in FIG. 19.

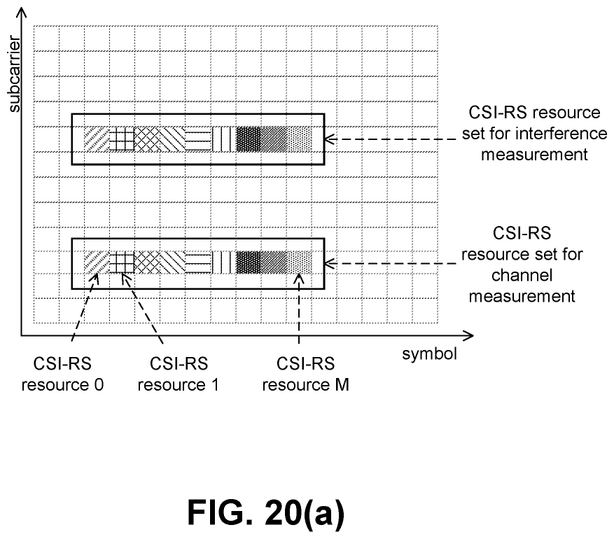

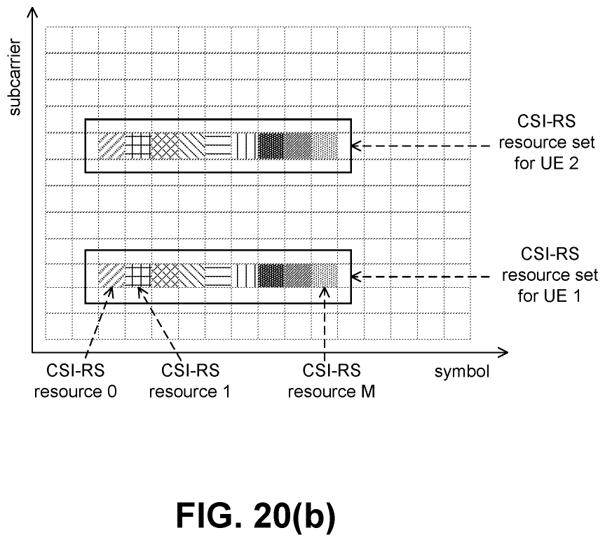

Multiple CSI-RS resource sets may be separated in the frequency domain. The CSI-RS resource sets may be simultaneously transmitted and/or dedicated for different tasks. For example, as shown in FIG. 20(a), one set of CSI-RS resources may be used for channel measurement and another set of CSI-RS resources may be used for interference measurement. A CSI resource set may include M+1 resources, which may be TDM'ed as discussed herein. A configured CSI-RS resource setting may be utilized in a multi-user scenario (e.g., the multiple user may use the same RIS), where different users may be scheduled with different CSI-RS resource sets and the resources (e.g., M+1 resources) for a user (e.g., a WTRU) may be FDM'ed or TDM'ed. FIG. 20(b) illustrates an example of two-user CSI-RS transmissions for an M-element or M-sub-surface RIS.

Sub-surfaces of an RIS may be mapped to CSI-RS resources and/or antenna ports. In the examples provided herein, a WTRU may acquire knowledge about the matrix Θ described herein, for example, via specification information and/or configuration information received from a network. The columns of Θ may correspond to M+1 pilots, among which a (e.g., one) pilot may correspond to a direct channel or path, and M other pilots may correspond to RIS-aided channels. The WTRU may be configured with a mapping between the columns of Θ and CSI-RS resources and/or antenna ports. The WTRU may use the mapping to estimate channels and/or generate an RIS CSI report. The direct channel or path may be estimated using the direct CSI-RS resource, which may be identified according to various methods described herein. The other M columns of Θ may correspond to different CSI-RS resources and/or antenna ports, which may be TDM'ed. The M columns of Θ may be mapped to CSI-RS resources and/or antenna ports that may be consecutive in time. For example, the left-most column (e.g., with a lowest column index) in Θ not corresponding to the direct channel may be mapped to a CSI-RS resource or antenna port not configured as a direct CSI-RS resource. The column may also be mapped to CSI-RS resource or antenna port that may have the lowest slot, the lowest symbol offset, etc.

The WTRU may use a mapping order to collect received symbols that may be associated with the vector y described herein. Note that vector y may include symbols received from multiple CSI-RS resources, symbols received from different antenna ports of a multi-port CSI-RS resource, or symbols received from antenna ports of different multi-port CSI-RS resources.

A mapping as described herein may be created based on RIS elements or sub-surfaces. For example, according to Equation 4, a first row of the matrix Θ may correspond to a direct path and the other rows of Θ may correspond to RIS-aided paths. This may mean that the first element in h and ĥ may correspond to the direct path. In other examples, any row of Θ may correspond to the direct path while the remaining rows may correspond to the RIS-aided paths.

The rows of Θ that may not correspond to a direct path may correspond to RIS elements. A mapping between RIS elements and rows of Θ may be defined (e.g., configured) to enable the WTRU to compute RIS parameters that may be based on horizontally or vertically adjacent RIS elements, corners and/or edge RIS elements, etc. The mapping between the RIS elements and the rows of Θ may be reflected in the mapping to elements of h and ĥ.

In examples, the first row of Θ not corresponding to the direct path (e.g., the second row of Θ in Equation 4) may correspond to an RIS element in a corner of the RIS. Such a row may correspond to the RIS element in the lower left corner. From this corner, adjacent RIS elements in the horizontal or vertical direction may be mapped to subsequent rows of Θ in order. If the RIS elements are mapped to Θ in the horizontal direction first, they may then be mapped in the vertical direction, and vice versa.

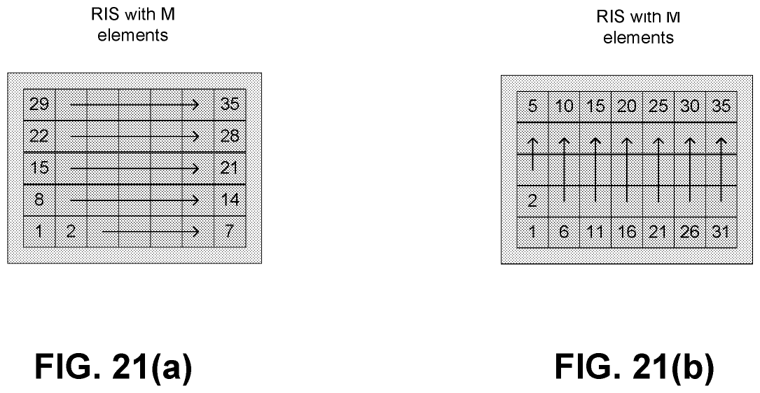

FIG. 21(a) illustrates an RIS element mapping order in which the horizontal direction may be mapped first. FIG. 21(b) illustrates an RIS element mapping order in which the vertical direction may be mapped first. The number associated with the RIS element may correspond to the row index in Θ for an RIS element, or to the element index in h and ĥ.

In the case of sub-surface based operation (e.g., according to Equation 8), a similar mapping between sub-surfaces and rows in Θ and elements in h and h may be known to the WTRU. A corner sub-surface such as the lower left corner may be mapped to the first row in Θ not corresponding to the direct path. Either horizontal first mapping or vertical first mapping, similar to that shown in FIG. 21(a) or FIG. 21(b), may be used for sub-surfaces. The mapping order (e.g., horizontal or vertical first) may be specified or configurable (e.g., by a network).

In examples, the WTRU may not know whether the first mapping direction is horizontal or vertical. The directions may be referred to as a first direction and a second direction, either of which may be horizontal, vertical or in another direction. Based on the mapping order, the WTRU may know if two RIS elements or sub-surfaces may be adjacent in the first or second direction, if RIS elements or sub-surfaces may be along an edge of the first or second direction, etc. RIS parameter reporting may refer to the first direction and/or the second direction.

The WTRU may know the relation between CSI-RS resources and ports, and/or the relation between adjacent elements and/or sub-surfaces in a first direction and/or a second direction. The WTRU may report RIS parameters according to the first direction and/or the second direction.

One or more RIS parameters may be defined and/or configured (e.g., for a WTRU). A WTRU may compute (e.g., determine) the CSI to be reported upon estimating various channels and/or parameters associated with the CSI. The channels may be represented by h=[d c^{s}] in the case of sub-surface-based channel estimation, or h=[d c] in the case of RIS-element based channel estimation. The other parameters associated with the CSI computation may include noise and/or interference related parameters that may be related to a transmission power, WTRU receiver processing parameters such as beamforming or spatial filtering associated with the receiver, etc. For simplicity of description, some examples may be described in the context of defining RIS states at an RIS element level (e.g., with Φ of length M, etc.), but the examples may also be applicable to cases where the RIS states are defined at a sub-surface level (e.g., with Φ^{s} of length S, etc.).

RIS CSI may be used by a network to adjust or optimize an RIS state for transmissions to a WTRU and/or receptions from the WTRU. For example, the network may select, based on the RIS CSI, RIS element factors Φ=[ϕ₁ . . . ϕ_{M}]^{T} such that ∠(c₁ϕ₁)= . . . =(c_{M}ϕ_{M})=∠d, where ∠d may denote the angle of a complex number d. Received signal quality may be enhanced if a (e.g., each) signal component reflected by an RIS element is received in-phase with a direct path d. In examples, the WTRU may determine (e.g., compute) a suitable RIS state Φ=[ϕ₁ . . . ϕ_{M}]^{T} and report the information to the network. This operation may be regarded as the WTRU recommending an RIS state.

A WTRU may compute a set of RIS parameters ( [symbol] ) based on a computed Φ=[ϕ₁ . . . ϕ_{M}]^{T}. The WTRU may report or recommend [symbol] , as a representation of Φ. The network may configure which parameters to be included in [symbol] , an RIS parameterization model or function, a parameter resolution, etc. The number of bits used to represent P may be lower than the number of bits used to represent Φ. An RIS state corresponding to [symbol] , denoted Φ̅, may be an approximation or quantization of Φ. The WTRU may select P such that ∥Φ−Φ̅∥ (e.g., a vector norm of errors) may be minimized. The WTRU may select [symbol] such that Φ may be the best RIS state among the RIS states that may correspond to a valid [symbol] . In various cases, it may be up to the WTRU to select a P and a corresponding Φ̅.

A WTRU may report an estimated direct channel (d) or the angle of an estimated direct channel (∠d). In examples, Φ may be adapted to d and d in P may not be reported. In examples, RIS parameters may be based on the angles and/or phases of Φ. The amplitudes of ϕₘ may vary with m (e.g., for semi-active or active RIS). For simplicity of description, RIS parameter related examples may be described herein from an angle and/or phase aspect, but the techniques disclosed herein may also be applicable to the amplitudes of ϕₘ and/or the complex parts of ϕₘ (e.g., ϕₘ may include complex numbers).

RIS element factors may be provided per sub-surface of an RIS. Given an estimate of h, a WTRU may compute a suitable Φ and report it to a network (e.g., directly and/or with some quantization). For example, the angle and/or phase of ϕₘ may be quantized (e.g., using W-ary PSK constellation and/or encoding), where each ∠ϕₘ may be quantized to log₂(W) bits, and the total number of bits may add up to M*log₂(W) (e.g., in the case of RIS-element level reporting) or S*log₂(W) (e.g., in the case of sub-surface level reporting).

Various phase shifts (e.g., angles) in Φ may be correlated. For example, the phase shifts in two adjacent RIS elements may be correlated. This may mean more CSI reporting with less overhead may be possible without sacrificing performance. A WTRU may compute a set of RIS parameters ( [symbol] ) based on the computed Φ=[ϕ₁ . . . ϕ_{M}]^{T}, and may report P instead of Φ. A CSI report may include parameters in [symbol] , for example, in a quantized form. Feedback overhead may be reduced if P is represented by fewer bits than Φ. Examples of parameterizations are discussed below.

A CSI feedback or report may include an indication of which phase-shift function may have been selected by a WTRU (e.g., at least in the case when the WTRU has been configured with multiple phase-shift functions for selection). In some cases (e.g., if the WTRU is in a far field), a linear or planar function may be suitable, whereas in other cases (e.g., if the WTRU is in a near field), a quadratic function may satisfy desired phase shifts.

Phase shifts across the RIS elements of an RIS may be linear or approximately (e.g., substantially) linear. The phase shifts may be linear in a certain direction across the RIS. For example, the phase shifts may be linear along the horizontal direction of the RIS and/or the vertical direction of the RIS, and the parameters associated with different lines may be different. The linear phase shifts along two directions may be seen as a planar phase shift. Let x denote a first direction and y denote a second direction (e.g., which may correspond to horizontal and vertical directions respectively). The phase shift line along the x-axis and/or the y-axis may be estimated and parameters for either or both lines may be reported in an RIS CSI report. For example, the following may be true: [symbol] ={αₓ, βₓ, α_{y}, β_{y}}, where exemplary equations in the x- and y-axes may be given by Equation 13 below:

$$\begin{matrix}{ϕ}_{{m}_{x}} = {α}_{x} {m}_{x} + {β}_{x} \\ {ϕ}_{{m}_{y}} = {α}_{y} {m}_{y} + {β}_{y}\end{matrix} \qquad ( 13 )$$

wherein mₓ∈{0, . . . , Mₓ−1} in the case of RIS-element based channel estimation or mₓ∈{0, . . . , Sₓ−1} in the case of sub-surface-based channel estimation. mₓ may be the RIS-element or sub-surface index along the x-axis. m_{y} may be the RIS-element or sub-surface index along the y-axis. The phase-shift in the m:th RIS-element or sub-surface with x/y indices (mₓ, m_{y}) may be ϕₘ=mₓ+ϕm_{y}.

In some examples, it may be sufficient to report β=βₓ+β_{y}, since this parameter may describe the phase shift in the reference element or sub-surface with mₓ=m_{y}=0 (e.g., [symbol] ={αₓ, α_{y}, β}). This may be used as a representation of a plane, according to Equation 14 below:

$${ϕ}_{{m}_{x} , {m}_{y}} = {α}_{x} {m}_{x} + {α}_{y} {m}_{y} + β \qquad ( 14 )$$

The parameters in [symbol] may be quantized. αₓ and/or α_{y} may be reported and may include errors. For small values of mₓ and m_{y}, the errors may be negligible. For large values of mₓ and/or m_{y}, the errors (e.g., a total of the errors) may be significant. An example approach for reducing the errors introduced by the quantization of xx and/or ay may be to adjust the RIS element or sub-surface indexing, for example, such that b may represent a phase shift in the middle of the surface (or near the middle of the surface). For example, the following may be enforced for the x-direction:

$${m}_{x} ∈ \{ - \frac{{M}_{x}}{2} , … , \frac{{M}_{x}}{2} - 1 \} ,$$

and similarly for the y-direction and/or the case with sub-surfaces. As another example,

$${m}_{x} ∈ \{ - \frac{{M}_{x}}{2} - 1 , … , \frac{{M}_{x}}{2} \}$$

may be enforced.

An even number of elements or sub-surfaces may exist in one or both directions (e.g., x and/or y directions). The indexing of these elements or sub-surfaces may be shifted such that β may represent a phase-shift between the middle-two elements or an average between the middle-two elements (e.g., in the middle of the RIS). For example, with

$${m}_{x} ∈ \{ - \frac{{M}_{x}}{2} , … , \frac{{M}_{x}}{2} - 1 \} and {m}_{y} ∈ \{ - \frac{{M}_{y}}{2} , … , \frac{{M}_{y}}{2} - 1 \} ,$$

an example planar equation may be as follows:

$${ϕ}_{{m}_{x} , {m}_{y}} = {α}_{x} ( {m}_{x} + 1 / 2 ) + {α}_{y} ( {m}_{y} + 1 / 2 ) + β \qquad ( 15 )$$

An effective index (mₓ+½) may be provided as

$$- \frac{{M}_{x}}{2} + 1 / 2 , … , - 1 / 2 , 1 / 2 , … , \frac{{M}_{x}}{2} - 1 / 2$$

for the x-direction and similarly for the y-direction and/or sub-surfaces. This may provide a symmetric plane around the RIS center and/or around the phase shift value β.

A linear or planar phase shift across an RIS may not sufficiently represent the suitable phase shifts Φ computed by a WTRU. A quadratic component may be added to the linear or planar equation described herein. Equation 16 below shows such an example, in which [symbol] ={αₓ, βₓ, γₓ, α_{y}, β_{y}, γₓ}.

$$\begin{matrix}{ϕ}_{{m}_{x}} = {α}_{x} {m}_{x} + {β}_{x} + {γ}_{x} {m}_{x}^{2} \\ {ϕ}_{{m}_{y}} = {α}_{y} {m}_{y} + {β}_{y} + {γ}_{y} {m}_{y}^{2}\end{matrix} \qquad ( 16 )$$

As in the linear or planar case, βₓ and β_{y} may be combined into β=βₓ+β_{y} such that [symbol] ={αₓ, α_{y}, β, γₓ, γ_{y}}, as illustrated in Equation 17 below:

$${ϕ}_{{m}_{x} , {m}_{y}} = {α}_{x} {m}_{x} + {γ}_{x} {m}_{x}^{2} + {α}_{y} {m}_{y} + {γ}_{y} {m}_{y}^{2} + β \qquad ( 17 )$$

The quantization issue and/or indexing solutions (e.g., including replacing indices with effective indices such as mₓ+½), as discussed herein, may be applicable to the examples with a quadratic phase shift. A point (e.g., an extreme point such as a minimum or maximum) of Equation 17 may occur at

$${m}_{x} = - \frac{{α}_{x}}{2 {γ}_{x}} and {m}_{y} = - \frac{{α}_{y}}{2 {γ}_{y}} ,$$

or at mₓ=m_{y}=0 for the quadratic component. To fit the function with the Φ computed by the WTRU, a variable point (e.g., a variable extreme point) may be introduced, as illustrated by Equation 18 below:

$${ϕ}_{{m}_{x} , {m}_{y}} = {α}_{x} {m}_{x} + {{γ}_{x} ( {m}_{x} - {δ}_{x} )}^{2} + {α}_{y} {m}_{y} + {{γ}_{y} ( {m}_{y} - {δ}_{y} )}^{2} + β \qquad ( 18 )$$

Parameters δₓ and δ_{y} may be used to shift one or more points (e.g., the extreme points described herein) of the function in the RIS, with a resulting example RIS parameter set of [symbol] ={αₓ, α_{y}, β, γₓ, γ_{y}, δₓ, δ_{y}}.

The element indices of an RIS may be reported. As discussed herein, quantization errors in reported function parameters, such as, e.g., αₓ, α_{y}, γₓ, γ_{y}, may grow with larger RIS-element or sub-surface indices mₓ and m_{y}. For example, with the maximum value of mₓ being 1000, the quantization error in αₓ may be magnified by a factor 1000 at the RIS element with the maximum mₓ value. The quantization error in γₓ may be magnified by a factor

$${m}_{x}^{2} = 1 {0}^{6} .$$

A way to overcome this issue may be to avoid quantizing and/or reporting gradient parameters. A WTRU may report multiple RIS-element or sub-surface indices to indicate a rate of phase change (e.g., linear, quadratic, etc.) across the RIS. In a linear example, an RIS-element or sub-surface may be a first reference element such as a corner RIS-element or sub-surface (e.g., at mₓ=m_{y}=0). The WTRU may have computed a certain phase ϕ_{ref}=ϕ_{0,0} for the reference element. The WTRU may determine a second element or sub-surface in a direction (e.g., m̅ₓ in the x-direction and m̅_{y} in the y-direction) for which the phase offset (e.g., Δϕₓ and Δϕ_{y}) to the reference element may have a certain value (e.g., at least approximately), as illustrated by Equation 19 below. The second element or sub-surface may be a different element than the first reference element or sub-surface.

$$\begin{matrix}{ϕ}_{{\overline{m}}_{x} , 0} \approx {ϕ}_{0 , 0} + Δ {ϕ}_{x} \\ {ϕ}_{{\overline{m}}_{y} , 0} \approx {ϕ}_{0 , 0} + Δ {ϕ}_{y}\end{matrix} \qquad ( 19 )$$

A CSI report may include an RIS parameter set [symbol] ={ϕ_{0,0}, m̅ₓ, m̅_{y}, Δϕₓ, Δϕ_{y}}. The resolution of Δϕₓ and/or Δϕ_{y} may be low (e.g., the phase shifts may correspond to 4-PSK or 8-PSK). The sign of the phase shift may be included. The resolution or set of phase shifts for Δϕₓ and Δϕ_{y} may be configurable (e.g., with the same or different configuration for Δϕₓ and Δϕ_{y}). The set of phase offset values may include values greater than or equal to 2π. This may indicate that the phase may have shifted a full turn or more between the reference element and the second element. The WTRU may, for instance, select Δϕₓ and m̅ₓ such that |ϕ_{m̅}_{ₓ}_{,0}−(ϕ_{0,0}+Δϕₓ)| may be minimized (similar operations may be performed for the y-direction). The WTRU may select Δϕₓ and m̅ₓ such that

$$\frac{1}{{\overline{m}}_{x}} \vert {ϕ}_{{\overline{m}}_{x} , 0} - ( {ϕ}_{0 , 0} + Δ {ϕ}_{x} ) \vert$$

may be minimized (similar operations may be performed for the y-direction). The latter metric may correspond to minimization of the error of the gradient. Phase wrap-around may be included or excluded in the phase calculations described herein.

The number of phase wrap-arounds from the reference element to the second element may be included in an RIS parameter set (e.g., in x and/or y directions). In a numerical example, the WTRU may estimate channels, as discussed herein, and may determine a suitable RIS state Φ, which may include the suitable RIS-element state for one or more (e.g., each) of 16,384 RIS elements. The reference element with mₓ=m_{y}=0 may have an overall element index m=0, with phase shift ϕ_{0,0}=ϕ₀. Let the set of phase shifts for Δϕₓ be

$$\{ - 2 π , - \frac{3 π}{2} , - π , - \frac{π}{2} , \frac{π}{2} , \frac{3 π}{2} , π , 2 π \} .$$

The WTRU may determine that m̅ₓ=83 may have a phase shift

$${ϕ}_{83 , 0} \approx {ϕ}_{0 , 0} + \frac{3 π}{2} .$$

For the y-direction, the WTRU may determine that m̅_{y}=91 may have a phase shift

$${ϕ}_{91 , 0} \approx {ϕ}_{0 , 0} - \frac{π}{2} .$$

The WTRU may include the following parameters in a CSI report:

$$𝒫 = \{ {ϕ}_{0 , 0} , {\overline{m}}_{x} = 83 , {\overline{m}}_{y} = 91 , {Δϕ}_{x} = \frac{3 π}{2} , {Δϕ}_{y} = - \frac{π}{2} \} .$$

The number of bits for ϕ_{0,0} may represent the phase shift of the reference element, e.g., 8 bits for phase shifts according to 256-PSK constellation. The number of bits to represent m̅ₓ and m̅_{y} may be log₂(128)=7 bits, respectively. The number of bits to represent Δϕₓ and Δϕ_{y} may be log₂(8)=3 bits, respectively. This may add up to 8+7+7+3+3=28 bits to represent the linear or planar phase shifts across the 16,384-element RIS.

The second element (e.g., m̅ₓ and m̅_{y}) may correspond to a point (e.g., an extreme point) in the phase shift function (e.g., a minimum or maximum). The phase shift of the point (e.g., ϕ_{m̅}_{ₓ}_{,m̅}_{_{y}}) may be reported. The number of phase wrap arounds between the reference element and the second element may be reported. These operations may be combined with the assumption of a quadratic phase-shift function. The function gradients in the x- and/or y-axes at the reference element may be reported. The function gradient at the reference element in the direction of the second element may be reported. The function gradient at the second element may be zero (e.g., since it may be an extreme point).

The phase shifts of an RIS corner element or sub-surface may be reported. For example, [symbol] ={ϕ_{0,0}, ϕ_{M}_{ₓ}_{,0}, ϕ_{0,M}_{_{y}}, ϕ_{M}_{ₓ}_{,M}_{_{y}}} may represent the phases of the four corners. RIS parameters may include the number of phase wrap arounds between the corners in the x-direction Wₓ and/or in the y-direction W_{y}, e.g., [symbol] ={ϕ_{0,0}, ϕ_{M}_{ₓ}_{,0}, ϕ_{0,M}_{_{y}}, Φ_{M}_{ₓ}_{,M}_{_{y}}, Wₓ, W_{y}}.

The maximum number of RIS phase shifts may depend on the resolution of an RIS element (e.g., each RIS element). For a particular resolution b-bits, the total number of possible RIS phase shifts (2^{b}) may be considered to be forming a codebook. A (e.g., each) discrete phase value may be uniformly or non-uniformly drawn from the range of phase shifts [(−π)−π] that may be one period or one cycle of a signal.

A WTRU may be configured with a codebook, which may be a set C of C possible RIS states, e.g.,

$$𝒞 = \{ {Φ}_{0}^{cb} … {Φ}_{C - 1}^{cb} \} .$$

The codebook (or its construction) may be provided or configured fully or partly. The length of each vector

$${Φ}_{k}^{cb}$$

may match the length of Φ or Φ^{s}, for element-level or sub-surface level operation, respectively. In the case where Φ or Φ^{s} may be estimated from one or more multi-port CSI-RS, the length may correspond to the number of antenna ports in a multi-port CSI-RS resource, or to the total number of antenna ports across multiple multi-port CSI-RS resources. Using Φ^{s} as an example, the selected RIS state index k̅ (e.g., of [log₂(C)] bits) may be included in the reported RIS CSI parameter set [symbol] .

In examples, a WTRU may not estimate or compute Φ^{s}. The WTRU may select a

$${Φ}_{k}^{cb}$$

from [symbol] directly. For example, the WTRU may select the RIS state that may maximize an SNR, e.g.,

$$\overline{k} = arg {max}_{k} \vert c {Φ}_{k}^{cb} + d \vert .$$

In examples, the WTRU may estimate or compute Φ^{s} and select a

$${Φ}_{k}^{cb}$$

from [symbol] e.g., the

$${Φ}_{k}^{cb}$$

with a minimum distance from Φ^{s},

$$e . g . , \overline{k} = arg {max}_{k} \vert {Φ}_{k}^{cb} + {Φ}^{s} \vert .$$

The performance of a communication network may depend on different RIS parameters if an RIS is present in the communication network. These parameters may include the size of the RIS, the RIS operating configuration (e.g., per element or per sub-surface or complete surface), the resolution of phase shifters (b bits) in case of discrete phase RIS states, supporting RIS modulation, etc. For example, higher beamforming gains may be achieved if a greater number of RIS elements are utilized to serve a given user. A lower resolution of an (e.g., each) RIS element may introduce higher quantization errors (e.g., as compared to a higher bit resolution), thus affecting the performance. A metric such as an RIS quality indicator or RIS-QI may be used to capture the effect of RIS parameters on the performance of communication. The RIS-QI may be reported by the WTRU and used by a base station (e.g., a gNB) and/or an RIS controller to update or refine an RIS state. Based on an estimated channel between the RIS and the WTRU (e.g., a channel aided by the RIS), the WTRU may perform measurements on an RIS-aided link or path. The RIS-QI may be measured based on a target SINR. An SINR to RIS-QI mapping may be created.

Interpolation may be performed based on RIS parameters. A network may receive one or more RIS CSI reports from a WTRU, including [symbol] discussed herein. The network (e.g., a BS, a gNB, or an RIS controller) may reconstruct or estimate a recommended RIS state Φ̅ from [symbol] . If channel estimation and/or RIS state recommendation Φ̅ is already per RIS element, Φ̅ may be used directly, for example, by the base station to configure, activate, and/or indicate Φ̅ to the RIS. If the recommended RIS state Φ̅^{s} is per sub-surface, the network may perform an interpolation and/or extrapolation from the per sub-surface RIS states Φ̅^{s} to per RIS element RIS states Φ̅. The interpolation and/or extrapolation may take place in a network node such as a base station or a gNB, or at the RIS. Such a process may be illustrated by Equation 20 below:

$$\overline{Φ} = g ( {\overline{Φ}}^{s} ( 𝒫 ) ) \qquad ( 20 )$$

wherein

$${\overline{Φ}}^{s} ( 𝒫 ) = {[ {\overline{ϕ}}_{1}^{s} … {\overline{ϕ}}_{S}^{s} ]}^{T}$$

may be the recommended RIS state per sub-surface (e.g., with a dimension S×1) as reconstructed from (e.g., as a function of) the RIS CSI feedback parameters P. g(·) may be an interpolation or extrapolation function that may map an RIS state per sub-surface (e.g., with a dimension S×1) to an RIS state per RIS element (e.g., with a dimension M×1). Φ̅=[ϕ̅₁ . . . ϕ̅_{M}]^{T} may be the per RIS-element RIS state (e.g., with a dimension M×1) that may be obtained after interpolation or extrapolation of the WTRU-recommended per sub-surface RIS state Φ̅^{s}.

A sub-surface RIS state

$${\overline{ϕ}}_{j}^{s}$$

may be assigned to an RIS element within a sub-surface (e.g.,

$${\overline{ϕ}}_{m} = {\overline{ϕ}}_{j}^{s}$$

for an m∈Γⱼ), where the RIS element may be at the center or near the center of the sub-surface. The separation in the x and y directions between such an RIS element in different sub-surfaces to which the sub-surface RIS state may be assigned may be equal to the number of RIS elements per sub-surface in the x and y-directions (e.g., Mₓ/Sₓ and M_{y}/S_{y} in the x- and y-directions, respectively). If there is an even number of RIS elements per sub-surface, there may not be a single central element in a sub-surface in the x- and/or y-direction. In that case, RIS element indexing may be adjusted, for example, using an index as discussed herein. For example, two RIS elements in a sub-surface center may be given indices or locations

$${m}_{x}^{′} + 1 / 2 and {m}_{x}^{′} - 1 / 2 ( or {m}_{x}^{′} + 1 and {m}_{x}^{′} - 1 ) ,$$

where the index or location mₓ′ may correspond to a sub-surface center in the x-direction (and similarly in the y-direction) that may be assigned the sub-surface RIS state

$${\overline{ϕ}}_{j}^{s} .$$

Based on the set of RIS element indices or locations with assigned RIS states from Φ̅^{s}, interpolation and/or extrapolation may be performed to generate the remaining RIS states in Φ̅. Various forms of interpolation and/or extrapolation techniques may be applied, such as linear, quadratic, etc. For various examples with reported function parameters such as, e.g., linear/planar, quadratic, etc., per sub-surface parameters may be scaled to fit RIS element level interpolation or extrapolation. For example, a reported linear gradient αₓ (for sub-surfaces) may be scaled as

$${α}_{x}^{′} = \frac{{s}_{x}}{{M}_{x}} {α}_{x}$$

(e.g., the gradient may be reduced by the number of RIS elements per sub-surface in the x-direction). A reported quadratic parameter γₓ (e.g., for sub-surfaces) may be scaled as

$${γ}_{x}^{′} = {( \frac{{s}_{x}}{{M}_{x}} )}^{2} {γ}_{x}$$

(e.g., the quadratic parameter may be reduced by the number of RIS elements per sub-surface squared in the x-direction). Similar scaling may be applied in the y-direction.

In examples, a WTRU may be configured with CSI reporting parameters (e.g., which may also be referred to herein as CSI measurement parameters) associated with an RIS. The CSI reporting parameters may include, for example, CSI-RS resources, channel and/or interference related parameters (e.g., CQI, RI, PMI, CRI, RIS-QI, etc.) to be measured, and/or other RIS-related configuration information (e.g., parameters) such as the number of sub-surfaces or elements in the x and/or y directions of the RIS. The WTRU may receive (e.g., be scheduled with) the CSI-RS resources, compute RIS parameters (e.g., RIS CSI related parameters such as CQI, RI, RIS-QI, etc.), and/or report the RIS parameters in a CSI report.

In examples, an RIS may report its capabilities to a network such as a base station. The RIS may be provided with sub-surface (or RIS element) related configuration information and/or time-domain configuration information. The RIS may apply the sub-surface (or RIS element) configuration information, for example, during time instances determined based on configuration signaling, an activation command, an explicit or implicit indication, a triggering event, etc. The RIS may receive an RIS-element level RIS state (e.g., from a network or a WTRU). The RIS may apply the RIS-element level RIS state, for example, during time instances determined based on configuration signaling, an activation command, an explicit or implicit indication, a triggering event, etc.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein may consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
receive, from a network device, measurement configuration information that indicates at least a first measurement resource and a second measurement resource, wherein the first measurement resource is associated with a first transmission path associated with a first subset of elements of a reconfigurable intelligence surface (RIS), and wherein the second measurement resource is associated with a second transmission path independent of the RIS;
perform a first measurement using the first measurement resource indicated by the measurement configuration information, wherein the first measurement is performed based on a first reference signal received via the first transmission path;
perform a second measurement using the second measurement resource indicated by the measurement configuration information, wherein the second measurement is performed based on a second reference signal received via the second transmission path; and
transmit a report that comprises information regarding at least one of the first measurement or the second measurement to the network device.

2. The WTRU of claim 1, wherein at least one of the first reference signal or the second reference signal includes a channel state information (CSI) reference signal, and wherein the report transmitted to the network device includes a CSI report.

3. The WTRU of claim 2, wherein the measurement configuration information further indicates respective channel quality parameters to be measured using the first measurement resource and the second measurement resource.

4. The WTRU of claim 1, wherein the first reference signal and the second reference signal are received from a same multiple-input-multiple-output transmitter associated with the network device.

5. The WTRU of claim 1, wherein the measurement configuration information further indicates a third measurement resource associated with a third transmission path aided by a second subset of elements of the RIS, and wherein the processor is further configured to perform a third measurement based on a third reference signal received via the third transmission path.

6. The WTRU of claim 5, wherein the processor is configured to receive all or a subset of the first reference signal, the second reference signal, and the third reference signal via time-division multiplexing.

7. The WTRU of claim 5, wherein the processor is configured to receive the first reference signal, the second reference signal, and the third reference signal during a reference signal transmission burst that includes multiple time slots.

8. The WTRU of claim 1, wherein the measurement configuration information further indicates that the first measurement resource and the second measurement resource belong to different measurement resource sets.

9. The WTRU of claim 1, wherein the processor being configured to transmit the report regarding at least one of the first measurement or the second measurement to the network device comprises the processor being configured to transmit a first report indicating a result of the first measurement using a first uplink grant, and transmit a second report indicating a result of the second measurement using a second uplink grant.

10. The WTRU of claim 1, wherein the measurement configuration information indicates that the first measurement resource and the second measurement resource are associated with respective resources indices, transmission times, transmission periodicities, or transmission power offsets, and wherein the processor is configured to determine that the first measurement resource is associated with the first transmission path associated with first subset of elements of the RIS and that the second measurement resource is associated with the second transmission path independent of the RIS based on the with respective resources indices, transmission times, transmission periodicities, or transmission power offsets associated with the first measurement resource and the second measurement resource.

11. A method implemented by a wireless transmit/receive unit (WTRU), the method comprising:
receiving, from a network device, measurement configuration information that indicates at least a first measurement resource and a second measurement resource, wherein the first measurement resource is associated with a first transmission path associated with a first subset of elements of a reconfigurable intelligence surface (RIS), and wherein the second measurement resource is associated with a second transmission path independent of the RIS;
performing a first measurement using the first measurement resource indicated by the measurement configuration information, wherein the first measurement is performed based on a first reference signal received via the first transmission path;
performing a second measurement using the second measurement resource indicated by the measurement configuration information, wherein the second measurement is performed based on a second reference signal received via the second transmission path; and
transmitting a report that comprises information regarding at least one of the first measurement or the second measurement to the network device.

12. The method of claim 11, wherein the first reference signal and the second reference signal are received from a same multiple-input-multiple-output transmitter associated with the network device.

13. The method of claim 11, wherein the measurement configuration information further indicates a third measurement resource associated with a third transmission path associated with a second subset of elements of the RIS, and wherein the method further comprises performing a third measurement based on a third reference signal received via the third transmission path.

14. The method of claim 13, wherein all or a subset of the first reference signal, the second reference signal, and the third reference signal are received via time-division multiplexing during a reference signal transmission burst that includes multiple time slots.

15. A network device, comprising:
a processor configured to:
receive information regarding a reconfigurable intelligence surface (RIS);
send measurement configuration to a wireless transmit/receive unit (WTRU), wherein the measurement configuration information indicates at least a first measurement resource and a second measurement resource, wherein the first measurement resource is associated with a first transmission path to the WTRU that uses the RIS, and wherein the second measurement resource is associated with a second transmission path to the WTRU that is independent of the RIS;
receive a report from the WTRU, wherein the report indicates a result of at least one of a first measurement performed based on the first measurement resource or a second measurement performed based on the second measurement resource;
determine whether to update a state of the RIS based on the report received from the WTRU; and
based on a determination to update the state of the RIS, send a configuration message to the RIS, wherein the configuration message indicates at least that the state of the RIS is to be updated.

16. The WTRU of claim 1, wherein the RIS comprises a first sub-subface and a second sub-subface, and wherein the first subset of elements constitutes the first sub-surface of the RIS.

17. The WTRU of claim 5, wherein the RIS comprises a first sub-subface and a second sub-subface, wherein the first subset of elements constitutes the first sub-surface of the RIS and wherein the second subset of elements constitutes the second sub-surface of the RIS.

18. The method of claim 11, wherein the RIS comprises a first sub-subface and a second sub-subface, and wherein the first subset of elements constitutes the first sub-surface of the RIS.

19. The network device of claim 15, wherein the RIS comprises a first sub-subface and a second sub-subface, and wherein the first measurement resource is configured for the first sub-surface of the RIS.

20. The network device of claim 19, wherein the measurement configuration information further indicates a third measurement resource associated with the second sub-surface of the RIS.
